(19) United States
(12) Patent Application Publication
(10) Pub. No.: US 2026/0368805 A1
(43) Pub. Date: Nov. 19, 2026

(54) SYSTEMS AND METHODS FOR FINANCIAL ALLOCATION RELATING TO PERSONAL INCOME MANAGEMENT

(71) Applicant: JPMorgan Chase Bank, N.A., New York, NY (US)

(72) Inventors: Amber StClair, Heartland, TX (US); Benjamin Barrer, Dallas, TX (US)

(21) Appl. No.: 19/674,720

(22) Filed: May 12, 2026

Related U.S. Application Data
(60) Provisional application No. 63/804,829, filed on May 13, 2025.

(51) Int. Cl. G06Q 40/02; G06Q 40/06

(52) U.S. Cl. CPC G06Q 40/0225; G06Q 40/0631

(57) ABSTRACT

Devices, methods, and systems for allocating funds into one or more subledgers in a bank account are provided. A device includes at least one memory and at least one processor communicatively connected with the at least one memory. The at least one processor is operable to execute code to cause the device to: receive a request from a user to open or access at least one bank account associated with a bank; receive one or more subledgers for the at least one bank account; create the one or more subledgers in the at least one bank account; receive at least one allocation strategy for the one or more subledgers; receive funds from at least one source; determine which of the one or more subledgers to deposit the funds into based on the at least one allocation strategy; and deposit funds from the at least one source into the one or more subledgers.

### CROSS REFERENCE TO RELATED APPLICATIONS

This application claims the benefit of U.S. Provisional Application No. 63/804,829, entitled “SYSTEMS AND METHODS FOR FINANCIAL ALLOCATION RELATING TO PERSONAL INCOME MANAGEMENT”, filed on May 13, 2025, the entire contents of which are hereby incorporated by reference herein.

### TECHNICAL FIELD

The present disclosure relates to bank account systems. More particularly, the examples of the present disclosure relate to systems and methods for allocating multiple income streams into one or more subledgers within at least one bank account of a user.

### BACKGROUND

Managing personal finances can be a challenging and mentally demanding process, especially when dealing with multiple income sources. This can lead to difficulties in maintaining financial discipline. Tracking and organizing finances can be particularly difficult when all income streams are funneled into a single bank account, which can obscure clarity and control over one's financial situation. Without a clear grasp of financial status and history, future financial planning may become intimidating and overwhelming. Ultimately, challenges in managing personal finances can negatively impact the ability to make sound financial decisions.

### SUMMARY

Systems and methods for allocating funds to one or more subledgers in a bank account are provided.

In some aspects, the techniques described herein relate to a device. The device includes at least one memory storing processor-executable code and at least one processor. The at least one processor is communicatively connected with the at least one memory and individually or collectively operable to execute the code to cause the device to: receive a request from a user to open or access at least one bank account associated with a bank; receive one or more subledgers for the at least one bank account; create the one or more subledgers in the at least one bank account; receive at least one allocation strategy for the one or more subledgers; receive funds from at least one source; determine which of the one or more subledgers to deposit the funds into based on the at least one allocation strategy; and deposit funds from the at least one source into the one or more subledgers.

In some instances, the at least one processor operable to execute the code further causes the device to save the at least one allocation strategy in a database associated with the bank.

In some instances, the one or more subledgers in the at least one bank account are provided by the user.

In other instances, the one or more subledgers in the at least one bank account are selected by the user from a list provided by the bank or one or more artificial (AI) agents associated with the bank.

In some instances, the at least one source is a company, a financial institution, a payment service, an individual, a financial instrument, or any combination thereof.

In some instances, the at least one allocation strategy is provided by the user.

In some instances, one or more AI agents associated with the bank provide a recommendation to modify the at least one allocation strategy via a user interface.

In some instances, the user accepts or rejects the recommendation to modify the at least one allocation strategy via the user interface.

In some aspects, the techniques described herein relate to a method. The method includes: receiving deposit data for funds deposited into at least one bank account via at least one AI agent, wherein the funds are from at least one source; receiving user data associated with a user of the at least one bank account at the at least one AI agent; outputting a recommendation of the at least one AI agent based at least in part on the deposit data and the user data, wherein the recommendation is a strategy to allocate a portion of the funds from the at least one source into the one or more subledgers in the at least one bank account; and receiving a response from the user regarding the recommendation of the at least one AI agent.

In some instances, the response from the user is an acceptance, a rejection or an inquiry.

In some instances, the response from the user is an acceptance, and the method further includes depositing the portion of the funds from the at least one source into the at least one subledger in accordance with the recommendation of the at least one AI agent.

In some instances, the deposit data includes one or more of a deposit amount, a deposit time, a deposit date, a type of deposit, a source of the deposit, deposit frequency, deposit amount variability, or deposit amount consistency.

In some instances, the user data includes one or more of user demographics data, user location data, user calendar data, user life event data, user financial goals data, user preferences, user transaction history, user risk tolerance, or user financial stress signals.

In some instances, the method further includes providing a nudge to the user if the response is not received within a time period.

In some instances, the recommendation of the at least one AI agent is provided via a user interface, and the response from the user is received via the user interface.

In some aspects, the techniques described herein relate to a system. The system includes: at least one AI agent; at least one memory storing processor-executable code; and at least one processor. The at least processor is communicatively connected with the at least one memory individually or collectively operable to execute the code to cause the system to: receive a deposit event for a bank account of a user via the at least one AI agent, wherein the deposit event includes data; generate a contextual output using all or a portion of the data; generate a behavioral output using all or a portion of the data; generate a subledger allocation strategy using the contextual output and the behavioral output; and provide the subledger allocation strategy to the user via a user interface.

In some instances, the data includes data about the deposit event or data about the user of the bank account.

In some instances, the system further includes a contextual awareness engine, wherein the contextual output is generated by the contextual awareness engine, and a behavioral economics module, wherein the behavioral output is generated by the behavioral economics module.

In some instances, the at least one processor operable to execute the code further causes the system to receive an acceptance of the subledger allocation strategy from the user via the user interface and implement the subledger allocation strategy.

In some instances, the at least one processor operable to execute the code further causes the system to modify the subledger allocation strategy based on feedback from the user.

### BRIEF DESCRIPTION OF THE DRAWINGS

FIG. 1 is a schematic diagram of an example system for depositing funds, in accordance with one or more aspects of the present disclosure;

FIG. 2 is a flowchart of method for depositing funds into one or more bank accounts, in accordance with one or more aspects of the present disclosure;

FIGS. 3A and 3B depict an example strategy for depositing funds into one or more bank accounts and/or one more subledgers in one or more bank accounts, in accordance with one or more aspects of the present disclosure;

FIG. 4 is an example strategy for depositing funds into one or more bank accounts and/or one or more subledgers in one or more bank accounts, in accordance with one or more aspects of the present disclosure;

FIG. 5 is an example strategy for depositing funds into one or more bank accounts and/or one or more subledgers in one or more bank accounts, in accordance with one or more aspects of the present disclosure;

FIG. 6 is flowchart of an example method of depositing funds into a bank account having one or more subledgers, in accordance with one or more aspects of the present disclosure;

FIG. 7 is a block diagram of an example allocation system, in accordance with one or more aspects of the present disclosure;

FIG. 8 is a block diagram of a contextual awareness engine of the allocation system of FIG. 7, in accordance with one or more aspects of the present disclosure;

FIG. 9 is a block diagram of a behavioral economics module of the allocation system of FIG. 7, in accordance with one or more aspects of the present disclosure;

FIG. 10 is a flowchart of a method of using an AI agent to allocate funds into one or more bank accounts and/or into subledgers in one or more bank accounts, according to disclosed examples; and

FIG. 11 is a schematic of a computer system that supports allocation of funds into one or more bank accounts and/or into subledgers in one or more bank accounts, in accordance with one or more aspects of the present disclosure.

### DETAILED DESCRIPTION

The present disclosure provides systems and methods for allocating multiple income streams into one or more bank accounts and/or one or more subledgers within one or more bank accounts of a user. The one or more bank accounts and the one or more subledgers can be selected by the user. The user may also select or create one or more bank account and/or partition allocations strategies for the income streams. The present disclosure also provides at least one artificial intelligence (AI) agent to assist with providing income allocation strategies or other information to the user.

The at least one AI agent discussed herein may be designed to enhance personal and business banking applications (e.g., web or mobile) by providing a user with tailored financial recommendations or tools. In some instances, the at least one AI agent may recommend income allocation strategies or suggest financial goals based on a variety of parameters including, for example, personal identification factors such as user demographics, historical income and spending data, transaction history and habits, deposit and transaction types, survey responses provided by the user, or the like.

The at least one AI agent may analyze patterns, such as income deposit amounts, deposit amount variability, deposit amount consistency, transaction types, and expense amounts, to help a user improve their financial strategies and help reach their goals. In some instances, the at least one AI agent may utilize preset “buckets” or subledgers to help a user allocate funds effectively and may track spending using merchant category codes to determine which bank account and/or subledger to deduct from. Although the term “subledgers” is used throughout the application, “subledgers” may also be referred to as “buckets”, “envelopes”, “partitions”, “vaults”, “sub-accounts”, or the like. In other instances, a user or the at least one AI agent may define or set overflow rules for when a bank account or subledger cap is hit or unexpected income occurs; in other instances, the user or the at least one AI agent may set a minimum threshold for one or more bank accounts and/or subledgers. In further instances, the at least one AI agent may ask a user to confirm ambiguous transactions (e.g., which bank account or subledger a deposit or withdrawal belongs to).

The at least one AI agent may also send nudges, alerts, or other notifications to the users to encourage user engagement. For example, the at least one AI agent may introduce new features to the user and/or encourage usage of existing features. In other examples, the at least one AI agent may send optimization nudges to improve efficiency or effectiveness of use (e.g., whether a user's allocation strategy is recurring or a one-time action). The at least one AI agent may incorporate user feedback on recommendations to improve future interactions and notifications.

The at least one AI agent may further track user engagement metrics (e.g., before-and-after behaviors) to refine recommendations and notifications. For example, the at least one AI agent may track and benchmark metrics such as the average number of bank accounts and/or subledgers a user has in their bank accounts before and after nudges, whether a user implemented a recommended allocation strategy, and user engagement with notifications or recommendations.

In other instances, the at least one AI agent may provide users with updates on their progress toward financial goals. For example, the at least one AI agent may generate projections for goal completion based on current or recommended income allocation strategies.

The at least one AI agent may further improve efficiency by leverages existing transaction mapping (e.g., transaction codes and descriptions) to present user-friendly transaction histories and may enable integration with other financial tools for a seamless experience. The at least one AI agent, however, may not provide specific investment advice or detailed financial guidance. Instead, it may operate in the intermediate financial space between daily cash flow management and long-term savings/planning.

The at least one AI agent may further prioritize data privacy, encryption, and security to protect user information while adhering to financial regulations and compliance guidelines. Furthermore, users can opt out of (or opt into) certain recommendations or interactions.

By leveraging advanced data analysis, user feedback, and engagement tracking, the at least one AI agent aims to provide a personalized, secure, and user-friendly banking experience that helps users achieve their financial goals efficiently.

Before any examples of the disclosure are explained in detail, it is to be understood that the disclosure is not limited in its application to the details of construction and the arrangement of components set forth in the following description or illustrated in the following drawings. The disclosure is capable of other examples and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use examples of the disclosure. Various modifications to the illustrated examples will be readily apparent to those skilled in the art, and generic principles presented herein can be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosure. Skilled artisans will recognize the examples provided herein have many useful alternatives and fall within the scope of examples of the disclosure.

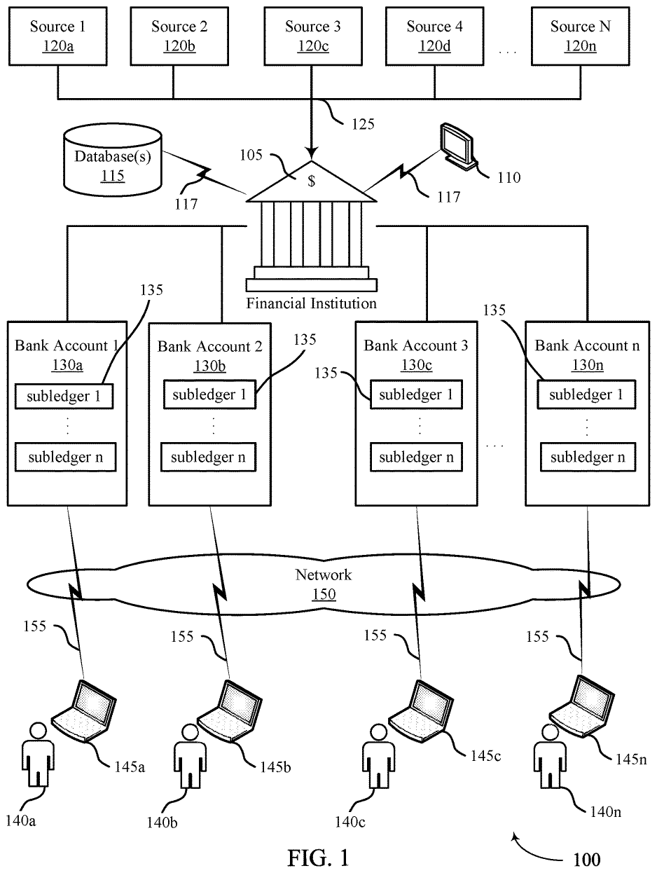

FIG. 1 depicts an example system 100 for depositing monetary funds. The system 100 may include a financial institution 105, such as a bank, which is configured to receive monetary funds from one or more sources 120 (e.g., 120a, 120b, 120c, 120d through 120n; collectively referred to as “sources 120”). The one or more sources 120 may transfer funds to the financial institution 105 over an automated clearinghouse (ACH) network 125. The financial institution 105 may be a bank or other financial institution or instrument capable of holding monetary funds for an individual, multiple individuals, or organizations in an account. In some instances, the financial institution 105 may include or be otherwise associated with at least one computing device 110 and/or at least one database 115, which may communicate over one or more wired or wireless communication links 117 via a system network (not shown). The one or more sources 120 may be one or more companies, one or more financial institutions, one or more payment services, one or more deposit or payment histories, one or more individuals, one or more financial instruments, or any combination thereof. In some instances, the one or more sources 120 may be a payroll provider for a company.

The financial institution 105 may provide one or more bank accounts 130a through 130n (collectively referred to as “bank accounts 130”). In some instances, the one or more bank accounts 130 may have one or more subledgers 135. In some instances, the one or more subledgers 135 may serve as a “bucket” in which all or a portion of the funds deposited into the one or more bank accounts 130 by the one or more sources 120 can be allocated. In some instances, the one or more bank accounts 130 and/or the one or more subledgers 135 may be pre-defined by the financial institution 105. In other instances, the one or more bank accounts 130 and/or the one or more subledgers 135 may be defined by a user associated with the one or more bank accounts 130. In further instances, the one or more bank accounts 130 and/or the one or more subledgers 135 may be a combination of one or more pre-defined or user-defined bank accounts or subledgers. The one or more bank accounts 130 and/or the one or more subledgers 135 may be given a name or other indicator to enable a user to quickly identify and organize the funds deposited into the one or more bank accounts 130 and/or the one or more subledgers 135. For example, the one or more bank accounts 130 and/or the one or more subledgers 135 may be given the name or labeled as follows: “Rent/Mortgage”, “Utilities”, “Groceries”, “Car Payment/Maintenance”, “Home Repairs”, “Cell Phone”, “Medical Bills”, “Transportation”, “College Savings”, “Travel”, “Entertainment”, “Gifts”, “Clothing”, “Emergency Fund”, “Discretionary”, “Date Night”, “Investment”, or the like.

The one or more bank accounts 130 may be associated with one or more users 140. For example, a Bank Account 1 130a may be associated with a User 140a, a Bank Account 2 130b may be associated with a User 140b, a Bank Account 3 130c may be associated with a User 140c, and so on. The one or more bank accounts 130 may have been opened at the financial institution 105 at the request of the one or more users 140. In some instances, more than one bank account 130 may be associated with a single user 140. For example, the User 140c may be associated with two bank accounts, for example, Bank Account 3 130c and a Bank Account 4 (not shown). In other examples, the User 140c may be associated with more than two bank accounts 130.

The one or more users 140 (e.g., 140a, 140b, 140c through 140n; collectively referred to as “users 140”) may be able to access one or more associated bank accounts 130a, 130b, 130c through 130n, respectively, using one or more user devices 145a, 145b, 145c through 145n, respectively (collectively referred to as “user devices 145”). The user devices 145 may be configured to access the one or more bank accounts 130 over a network 150. The one or more user devices 145 and/or the at least one computing device 110 may be any type of computing device, such as a desktop computer, laptop, mobile phone, tablet, database, personal digital assistant (PDA), tablet, personal computer, or other electronic device. The one or more user devices 145 and/or the at least one computing device 110 may be enabled with Internet access and locatable by the network 150 or another network. In some aspects, the one or more user devices 145 and/or the at least one computing device 110 may be configured to transmit instructions to control various devices, receive data or other signals from external devices, and transmit the received data or other data to a network (e.g., the network 150 and/or the system network), a server, or another computing device (e.g., the at least one database 115) connected via the network.

The one or more users 140 may be able to connect to the network 150 via at least one wired or wireless communication link 155 between the one or more user devices 145 and the network 150, which may be via other networks. For example, the at least one communication link 155 may incorporate one or more other networks between a user device 145 and the network 150.

In some examples, the network 150 and/or the system network (not shown) may include an Automatic Data Processing (ADP) device coupled to a plurality of server devices that may host a plurality of databases and a plurality of client or user devices via the network 150. The ADP device may store one or more applications that can include executable instructions that, when executed by the ADP device, cause the ADP device to perform desired actions, such as to transmit, receive, or otherwise process network messages, for example, and to perform other actions described and illustrated herein with reference to the figures. The applications may be implemented as modules or components of other applications. Further, the applications can be implemented as operating system extensions, modules, plugins, or the like.

In some examples, the network 150 and/or the system network (not shown) may be a local area network (LAN), a wide area network (WAN), or other types of networks, supporting protocols like transmission control protocol/Internet protocol (TCP/IP) over Ethernet. In some instances, the network 150 and/or the system network (not shown) may be a cloud network. The network 150 and/or the system network (not shown) may serve as a system hub, providing computational resources and storage capabilities. The network 150 and/or the system network (not shown) may include resources to manage and deliver computing services over the Internet or other communication forms. The network 150 and/or the system network (not shown) may be executed within or as a virtual machine or a virtual server that may be managed in a cloud-based computing environment. Also, the application(s), and even the ADP device itself, may be located on one or more virtual server(s) running in a cloud-based computing environment rather than being tied to one or more specific physical network computing devices. For example, the application(s) may be running in one or more virtual machines (VMs). In some examples the network 150 and/or the system network (not shown) may include elements such as data centers, virtualized resources, cloud services, and security tools. In some aspects, the network 150 and/or the system network (not shown) may utilize data centers that also host servers capable of processing, storing, and managing network traffic, allowing centralized control without on-site hardware.

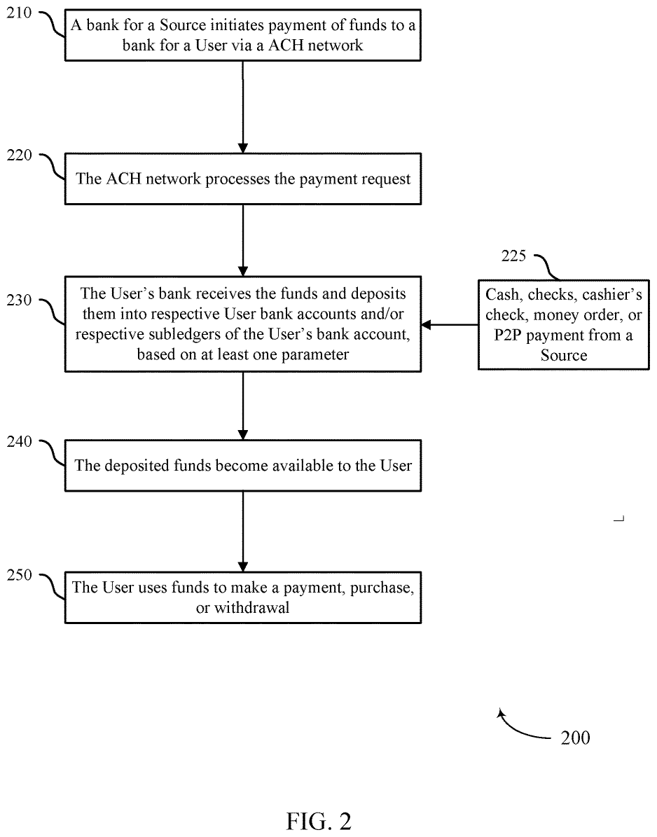

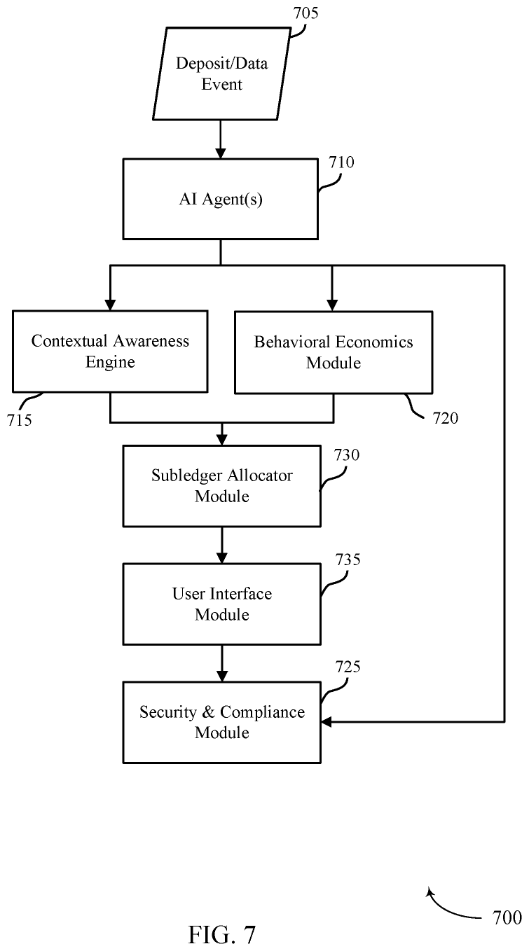

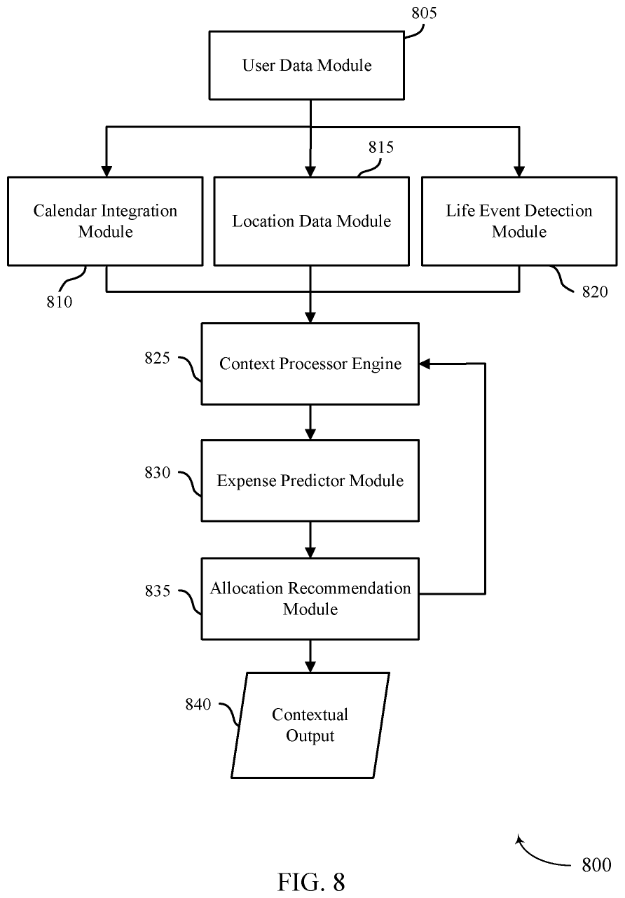

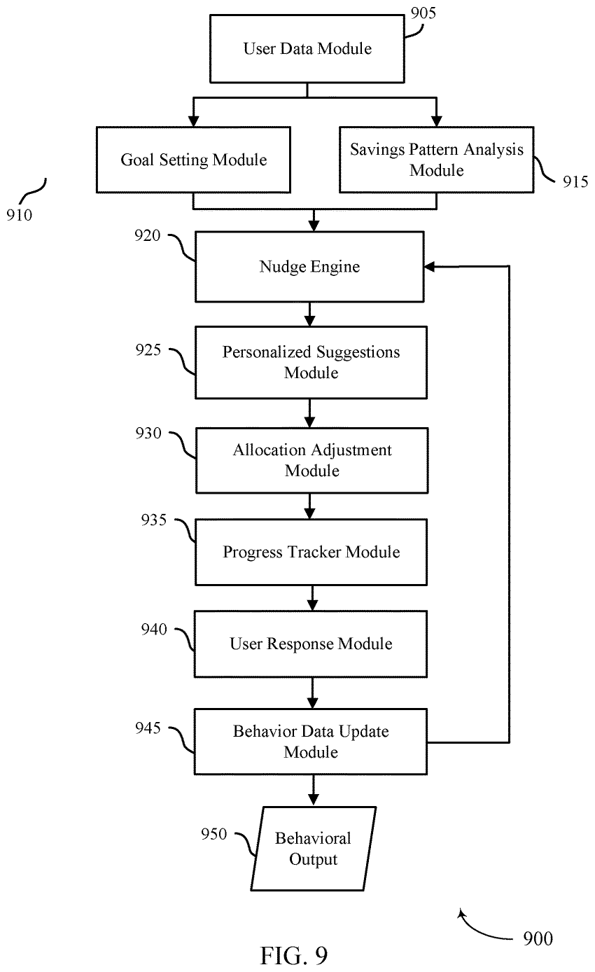

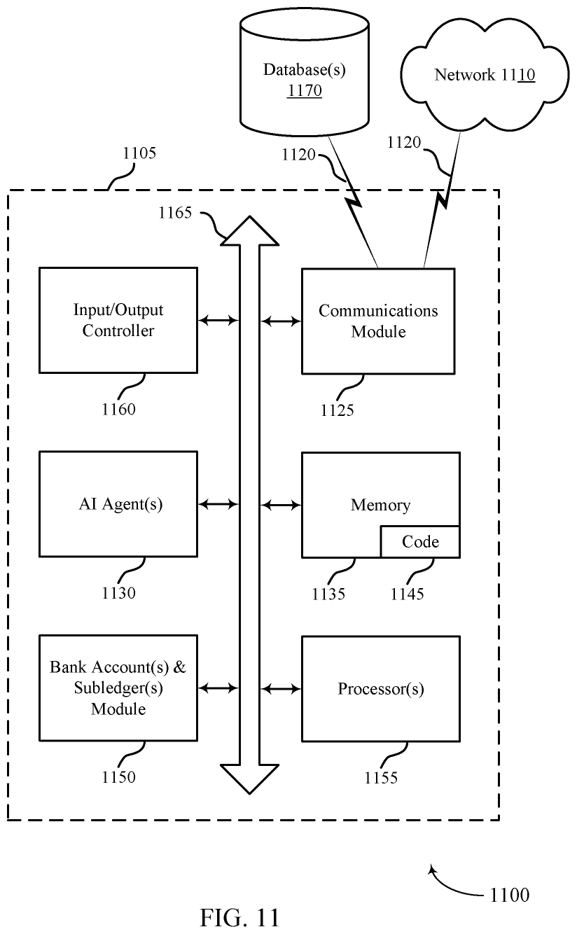

FIG. 2 depicts a flowchart of a method 200 of depositing monetary funds into one or more bank accounts at a bank or other financial institution of a user. The method 200 illustrates a technique described herein for providing a financial allocation system for personalized income management. The method 200 may perform partitioning of the one or more user bank accounts into one or more subledgers and may provide options for the user to easily manage multiple monetary or data streams. In some examples, the method 200 may be performed or implemented all, or in part, by the system 100 of FIG. 1, the allocation system 700 of FIG. 7, the context awareness engine 800 of FIG. 8, the behavioral economics module 900 of FIG. 9, the computer system 1100 of FIG. 11, and/or by one or more computing devices or components of such systems, engines, or modules (e.g., one or more AI agents).

At 210, a bank or other financial institution for a source of monetary funds (e.g., the one or more sources 120) may initiate a request for payment of funds with the user's bank by sending funds to an ACH network (e.g., ACH network 125). In some examples, the source of monetary funds may be an employer, and the user may be an employee of the source, and the employee-user has requested the employer-source to pay the user via direct deposit into the user's bank account. In other examples, the source of monetary funds may be company for which the user is not an employee (e.g., contract-worker), another individual, a real estate property, another financial instrument (e.g., crypto currency, stocks, retirement fund), etc.

At 220, the ACH network may process the request for payment. In some instances, the ACH network may sort and route the payment from the source to the user's bank.

At 225, one or more other forms of payment (e.g., cash, check, cashier's check, money order, and/or peer-to-peer (“P2P”) payments) for an amount of funds may be provided to the user's bank by the same or a different source of monetary funds.

At 230, the user's bank may receive the funds from the ACH network or from the other forms of payment. The user's bank may deposit the received funds into one or more respective bank accounts of the user and/or into respective subledgers of the user's one or more bank accounts. If the user has one or more bank accounts and/or one or more subledgers in one or more bank accounts, all or some of the received funds may be deposited into the one or more bank accounts and/or the one or more subledgers. The funds may be deposited into certain bank accounts and/or subledgers within one or more bank accounts based on at least one parameter. Example parameters may include an identity of the source of the funds, an allocation strategy identified by the user or the AI agent (described in further detail below), a designation of the funds, a current balance of the bank account or subledger or other subledgers in a set of subledgers, a category associated with the funds, bank account, or subledger, a current budget status associated with the category, one or more goals identified by the user or the AI agent, a request from the user, a type of the request, a type of deposit or transaction, or the like. The bank may deposit the cash or the amount of the check, cashier's check, money order, and/or P2P payment into the user's one or more bank accounts.

At 240, the deposited funds may become available to the user in alignment with the allocation strategy. In some examples, the funds may always be available to the user. In other examples, the allocation strategy may designate some funds as off-limits unless certain parameters are met, such as upon a specific input from the user. In other examples, the funds may be allocated based on a specific deposit or transaction type, which may be processed by the financial institution. In certain examples, the funds may be automatically handled by the AI agent as described herein.

At 250, the user may allocate all or a portion of the funds deposited in the one or more bank accounts and/or one or more subledgers of the one or more bank accounts to pay a bill, make a purchase, or make a withdrawal from the bank account (e.g., at an automated teller machine “ATM”). In some examples, the user may interact with the AI agent to determine how the funds will be used.

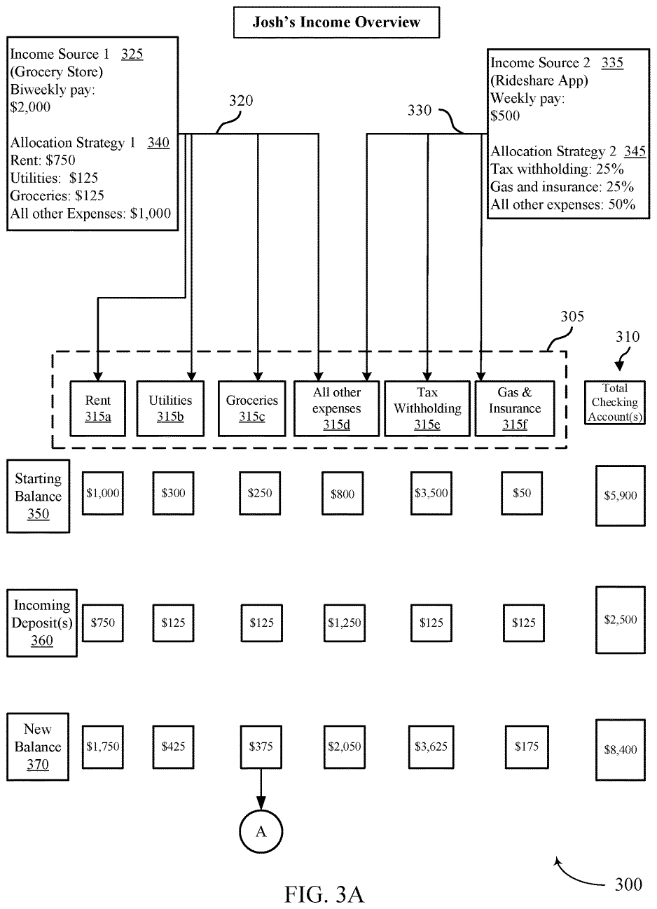

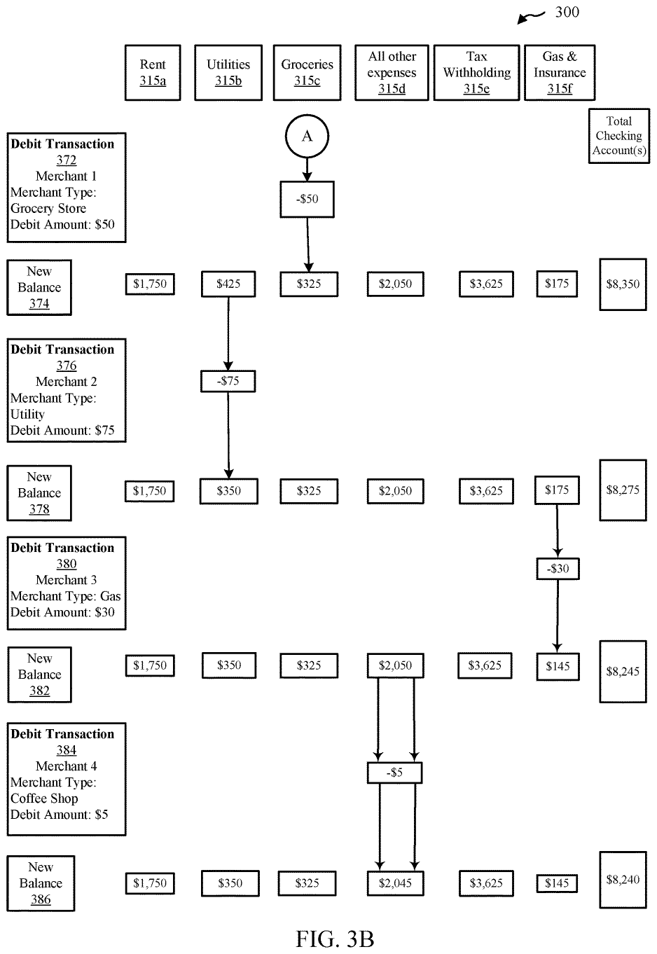

Turning to FIGS. 3A and 3B, an example financial allocation strategy 300 for a user (e.g., user 140) is depicted. For ease of reference, the allocation strategy shown in FIGS. 3A and 3B may be for a user having the name Josh. The financial allocation strategy 300 may be performed or implemented, all or in part, by the system 100 of FIG. 1, the allocation system 700 of FIG. 7, the contextual awareness engine 800 of FIG. 8, the behavioral economics module 900 of FIG. 9, the computer system 1100 of FIG. 11, and/or by one or more computing devices or components (e.g., one or more AI agents) of such systems, engines, or modules.

Josh may have a bank account 305 with a bank (e.g., financial institution 105). The bank account 305 may be a checking account or a savings account. In the example shown in FIGS. 3A and 3B, the bank account 305 is provided in the form of a checking account 310. In some instances, the user (e.g., Josh) may have more than one bank account with the bank or another financial institution.

Josh may have selected one or more subledgers 315 (e.g., 315a, 315b, 315c, 315d, 315e, 345f; collectively referred to as “subledgers 315”) for the bank account 305. The one or more subledgers 315 may include a label, name, or other indicator. In some instances, Josh may have selected the one or more subledgers 315 from a menu of pre-defined subledgers provided by the bank or AI agent. In other instances, Josh may have created or generated the one or more subledgers 315 using a subledger creation or generation tool provided by the bank, the AI agent, or another entity. In further instances, the one or more subledgers 315 may be a combination of pre-defined subledgers or user-generated subledgers.

As shown in FIGS. 3A and 3B, Josh's bank account 305 may have six subledgers. Although six subledgers are shown in this example, the bank account 305 may have zero subledgers or any number of subledgers 315. As shown in FIGS. 3A and 3B, in some instances, the subledgers 315 may include and be labeled as follows: “Rent” 315a, “Utilities” 315b, “Groceries” 315c, “All other expenses” 315d, “Tax withholding” 315e, and “Gas & Insurance” 315f. In some instances, the “All other expenses” subledger 315d may not be a separate subledger but rather function as a default to the general bank account 305.

Josh may have a first income stream 320 coming from a first source 325. The first source 325 may be a company that has hired Josh as an employee (e.g., an employee who receives a W2 from the Internal Revenue Services or a “W2 employee”). Josh may receive a paycheck from the company, his employer, at a regular interval (e.g., weekly, twice a month, monthly, etc.) or at irregular intervals. In the example shown in FIGS. 3A and 3B, Josh's employer may be a grocery store and the interval at which Josh may receive a paycheck from the first source 325 may be biweekly (i.e., twice a month), and the amount of each paycheck may be $2,000. Josh may deposit the paycheck into his bank account 305 manually (e.g., via an ATM, bank teller, or an application on Josh's user device) or the first source 325 may pay Josh via direct deposit via ACH with Josh's bank.

Josh may also have a second income stream 330 coming from a second source 335. Josh may not be a “W2 employee” of the second source 335 but may perform contract work for the second source 335. The second source 335 may send Josh payments for the work he performs at the same or different interval as the first source 325. In some instances, Josh may only receive payment if he works during a certain interval (e.g., a week, two weeks, three weeks, a month, etc.). In other instances, Josh may receive payment after each job or matter is performed for the second source 335. In the example of FIGS. 3A and 3B, the second source 335 may be a rideshare application for which Josh works, and Josh may receive a paycheck from the second source 335 on a weekly basis. The amount of the paycheck from the second source may be, for example, $500.

As shown in FIG. 3A, Josh may decide to allocate all or a portion of the first income stream 320 into the one or more subledgers 315. Likewise, Josh may decide to allocate all or a portion of his second income stream 330 into the one or more subledgers 315. The one or more subledgers 315 that Josh selects to allocate funds from the first income stream 320 may be the same or different than the one or more subledgers 315 that Josh selects to allocate the funds from the second income stream 330.

As shown in FIG. 3A, a first allocation strategy 340 may be used for the first income stream 320. In some instances, the user (e.g., Josh) may define the first allocation strategy 340; and in other instances, one or more AI agents, as discussed herein, may define the first allocation strategy 340. The first allocation strategy 340 may allocate one or more specific amounts or one or more percentages of the first income stream 320 into the one or more subledgers 315.

In an example, the first allocation strategy 340 may divide the first income stream 320 into four amounts (e.g., $750, $125, $125, and $1000) which may be deposited into four subledgers (e.g., 315a, 315b, 315c, and 315d). In other instances, the first income stream 320 may be divided into any number of amounts or percentages or not divided at all. Similarly, the first income stream 320 may be deposited into zero subledgers (e.g., deposited into the general bank account 305) or any number of subledgers. In the example depicted in FIGS. 3A and 3B, Josh has allocated a set amount of the first income stream 320 (e.g., the $2000 paycheck) received from the first source 325 to be deposited into four of the subledgers 315. For example, Josh may allocate $750 of the first income stream 320 for rent into the subledger 315a labeled “Rent”, $125 of the first income stream 320 for utilities into the subledger 315b labeled “Utilities”, $125 of the first income stream 320 for groceries into the subledger 315c labeled “Groceries”, and $1000 of the first income stream 320 for other expenses into the subledger 315d labeled “All other expenses”.

As shown in FIG. 3A, a second allocation strategy 345 may be used from the second income stream 330. In some instances, the user (e.g., Josh) may define the second allocation strategy 345; and in other instances, one or more AI agents, as discussed herein, may define the second allocation strategy 345. The second allocation strategy 345 may allocate one or more specific amounts or one or more percentages of the first income stream 320 into the one or more subledgers 315.

In an example, the second allocation strategy 345 may divide the second income stream 330 into three percentages (e.g., 25%, 25%, and 50%), and the amounts associated with the percentages may be deposited into three subledgers (e.g., 315d, 315e, and 315f). In other instances, the second income stream 330 may be divided into any number of amounts or percentages or not divided at all. Similarly, the second income stream 330 may be deposited into zero subledgers (e.g., deposited into the general bank account 305) or any number of subledgers. In the example of FIGS. 3A and 3B, Josh has allocated a set percentage of the second income stream 330 (e.g., the $500 paycheck) received from the second source 335 to be deposited into three of the subledgers 315. For example, Josh may allocate 25% of the second income stream 330 for tax withholdings into the subledger 315e labeled “Tax Withholding”, 25% of the second income stream 330 for gas or insurance for his vehicle into the subledger 315e labeled “Gas & Insurance”, and 50% of the second income stream 330 for other expenses into the subledger 315d labeled “All other expenses”.

In some instances, the total amount of the allocated funds from an income stream cannot exceed the amount of the income stream (e.g., $750+$125+$125+$1000≤$2000). In other instances, the total percentage of the allocated funds from an income stream cannot exceed 100% (e.g., 25%+25%+50%≤100%). In some instances, an allocation strategy where one or more set dollar amounts from an income stream are deposited into one or more subledgers may be implemented when the income stream is for a consistent amount. In other instances, an allocation strategy where one or more percentages from an income stream are deposited into one or more subledgers may be implemented when the income stream is not for a consistent amount and/or received at an irregular interval. In some instances, if all or a portion of an income stream is not allocated to a specific subledger, then the portion of the income stream not allocated may be deposited into a general bank account (e.g., bank account 305) by default.

In some instances, one or more caps or thresholds may be applied to one or more subledgers. The one or more caps may be associated with one or more timeframes. The cap and the timeframe for each subledger may be pre-defined or may be manually set or adjusted by the bank account user (e.g., Josh) or the AI agent. In some examples, the one or more caps or thresholds may be for a maximum amount that can be deposited in the one or more subledgers and in other cases, the one or more caps or thresholds may be for a minimum amount for the one or more subledgers. For example, Josh's rent each month may be $2000; thus, if the rent subledger 315a exceeds $2000 for the month of January or another time period, then any amount that would be over $2000 that is earmarked for the rent subledger 315a within the month of January may be reallocated to one or more of the other subledgers 315 (e.g., 315b, 315c, 315d, 315e, or 315f) or the general bank account 305. In another instance, Josh may not want the subledger 315c for groceries to go below $50 during any month or set timeframe. If Josh's purchases or withdrawals from the “Groceries” subledger 315c falls below $50, in some instances, Josh may receive an alert or other notification. In other instances, any overflow from another subledger (e.g., the rent subledger 315a) or any extra funds from the first income stream 320 may be automatically allocated to the “Groceries” subledger 315c if the amount in the “Groceries” subledger 315c falls below $50. In other examples, if a subledger is serving as a savings account for a future expense or event such as the purchase of a car, a downpayment on a home, a wedding, a vacation, etc., then the subledger may also have a cap. For example, if Josh wants to put a $15,000 downpayment on a home, then Josh may create a subledger for the downpayment and then cap the subledger at $15,000. There may be no timeframe associated with the subledger as it may take several months or years for the user (e.g., Josh) to reach the cap. Once the amount deposited in the subledger reaches the cap (e.g., $15,000), no additional funds may be deposited into the downpayment subledger. In some instances, the user (e.g., Josh) may select one or more subledgers for which they would like any overages deposited or the overages may automatically default to a catch-all subledger (e.g., subledger 315d for “All other expenses”), the general bank account (e.g., bank account 305), or another checking or savings account.

Continuing with FIGS. 3A and 3B, the bank account 305 may have a starting balance 350. The starting balance 350 may be a starting balance that is a total of all the funds in the bank account 305. In some instances, if the bank account 305 has one or more subledgers, then the starting balance 350 may be the total of the funds in each of the subledgers 315 as well as any funds in the general bank account 305. For example, the starting balance of the bank account 305 may be $5900, which is the total of the $1000 in the subledger 315a labeled “Rent”, the $300 in the subledger 315b labeled “Utilities”, the $250 in the subledger 315c labeled “Groceries”, the $800 in the subledger 315d labeled “All other expenses”, the $3500 in the subledger 315e labeled “Tax Withholding”, and $50 in the subledger 315f labeled “Gas & Insurance” ($1000+$300+$250+$800+$3500+$50=$5900).

One or more incoming deposits 360 for the bank account 305 may be from the first income stream 320, the second income stream 330, and/or another income stream. In the example in FIG. 3A, the one or more incoming deposits 360 for the bank account 305 may include the first income stream 320 and the second income stream 330 deposited according to the first allocation strategy 340 and the second allocation strategy 345, respectively. For example, the one or more incoming deposits 360 may include $750 from the first income stream 320, which is deposited into the subledger 315a, $125 from the first income stream 320, which is deposited into the subledger 315b, $125 from the first income stream 320, which is deposited into the subledger 315c, $1250 from the first income stream 320 and the second income stream 330 (e.g., $1000 from the first income stream 320 and $250=0.50×$500 from the second income stream 330), which is deposited in the subledger 315d, $125 (0.25×$500) from the second income stream 330, which is deposited into the subledger 315e, and $125 (0.25×$500) from the second income stream 330, which is deposited into the subledger 315f, for a total of $2500 in incoming deposits.

A new balance 370 from the bank account 305 may be calculated by adding the one or more incoming deposits 360 (e.g., $2500) to the starting balance 350 (e.g., $5900). For example, as shown in FIG. 3A, the new balance for the bank account 305 may be $8400 (e.g., $2500+$5900). Each of the subledgers 315 that received funds from the first income stream 320 and/or the second income stream 330 may also have a new balance 370 after the incoming deposit 360 is added to the starting balance 350. For example, the subledger 315a may have a new balance of $1750, the subledger 315b may have a new balance of $425, the subledger 315c may have a new balance of $375, the subledger 315d may have a new balance of $2050, the subledger 315e may have a new balance of $3625, and the subledger 315f may have a new balance of $175.

Turning to FIG. 3B, the bank account 305 may have a debit transaction 372 having a transaction type. For example, the transaction type may be a withdrawal, a refund, a purchase, or a bill payment. The debit transaction 372 may relate to a bill or purchase made using the bank account 305 at a first merchant having a merchant type. In some instances, the merchant type may be determined based on Merchant Category Codes (MCC). MCCs may be defined by a payment network, such as Visa® or Mastercard®, or by the bank (e.g., financial institution 105).

In the example shown in FIG. 3B, the first merchant may have a first merchant type. The first merchant type may be “Grocery Store”. The amount (e.g., $50) of the debit transaction 372 may be deducted from the bank account 305. In some instances, the debit transaction 372 may be for an item or service that falls within one of the subledgers 315. If the bank account 305 has a subledger 315 related to the debit transaction 372, then the debit transaction 372 may be applied to the associated subledger. For example, the debit transaction 372 may be for groceries in the amount of $50, and the $50 may be deducted from the subledger 315c labeled “Groceries”.

After the debit transaction 372 is applied to the bank account 305, the bank account 305 may have a new balance 374. For example, the bank account 305 in the example shown in FIG. 3B may have a new balance 374 of $8350 (e.g., $8400−$50). The subledger 315c may have a new balance 374 of $325 (e.g., $350−$50). The other subledgers for which the debit transaction 372 does not relate may remain the same (e.g., $1750 in subledger 315a, $425 in subledger 315b, $2050 in subledger 315d, $3625 in subledger 315e, and $175 in subledger 315f).

The bank account 305 may have another debit transaction 376 relating to a bill or purchase made using the bank account 305 at a second merchant. The second merchant may have a second merchant type. In the example shown in FIG. 3B, the second merchant type may be “Utility”. The amount (e.g., $75) of the debit transaction 376 may be deducted from the bank account 305. In some instances, the debit transaction 376 may be for an item or service that falls within one of the subledgers 315. If the bank account 305 has a subledger related to the debit transaction 376, then the debit transaction 376 may be applied to the associated subledger. For example, the debit transaction 376 may be for a utility in the amount of $75, and the $75 may be deducted from the subledger 315b labeled “Utilities”.

After the debit transaction 376 is applied to the bank account 305, the bank account 305 may have a new balance 378. For example, the bank account 305 in the example shown in FIG. 3B may have a new balance 378 of $8275 (e.g., $8350−$75). The subledger 315b may have a new balance 378 of $350 (e.g., $425−$75). The other subledgers for which the debit transaction 376 does not relate may remain the same (e.g., $1750 in subledger 315a, $325 in subledger 315c, $2050 in subledger 315d, $3625 in subledger 315e, and $175 in subledger 315f).

The bank account 305 may have another debit transaction 380 relating to a bill or purchase made using the bank account 305 at a third merchant. The third merchant may have a third merchant type. In the example shown in FIG. 3B, the third merchant type may be “Gas”. The amount (e.g., $30) of the debit transaction 380 may be deducted from the bank account 305. In some instances, the debit transaction 380 may be for an item or service that falls within one of the subledgers 315. If the bank account 305 has a subledger related to the debit transaction 380, then the debit transaction 380 may be applied to the associated subledger. For example, the debit transaction 380 may be for gas in the amount of $30, and the $30 may be deducted from the subledger 315f labeled “Gas & Insurance”.

After the debit transaction 380 is applied to the bank account 305, the bank account 305 may have a new balance 382. For example, the bank account 305 in the example shown in FIG. 3B may have a new balance 382 of $8245 (e.g., $8275−$30). The subledger 315f may have a new balance 382 of $145 (e.g., $175−$30). The other subledgers for which the debit transaction 380 does not relate may remain the same (e.g., $1750 in subledger 315a, $350 in subledger 315b, $325 in subledger 315c, $2050 in subledger 315d, and $3625 in subledger 315e).

The bank account 305 may have another debit transaction 384 relating to a bill or purchase made using the bank account 305 at a fourth merchant. The fourth merchant may have a fourth merchant type. In the example shown in FIG. 3B, the fourth merchant type may be “Coffee Shop”. The amount (e.g., $5) of the debit transaction 384 may be deducted from the bank account 305. In some instances, the debit transaction 384 may be for an item or service that falls within one of the subledgers 315. If the bank account 305 has a subledger related to the debit transaction 384, then the debit transaction 384 may be applied to the associated subledger. In some instances, the debit transaction 384 may not fall clearly within one of the subledgers 315a, 315b, 315c, 315e, or 315f. In some cases, one of the subledgers may be designated as a default subledger. For example, as shown in FIG. 3B, the subledger 315d labeled “All other expenses” may be the default subledger when debit transactions or expenses do not clearly fall within another subledger. In other instances, if the debit transaction 384 does not fall clearly within one of the subledgers, the amount of the debit transaction may be deducted from the general bank account 305.

After the debit transaction 384 is applied to the bank account 305, the bank account 305 may have a new balance 386. For example, the bank account 305 in the example shown in FIG. 3B may have a new balance 386 of $8240 (e.g., $8245−$5). The subledger 315d may have a new balance 386 of $2045 (e.g., $2050−$5). The other subledgers for which the debit transaction 384 did not relate may remain the same (e.g., $1750 in subledger 315a, $350 in subledger 315b, $325 in subledger 315c, $3625 in subledger 315e, and $145 in subledger 315f).

In some instances, the user (e.g., Josh) may have selected and designated or labeled one or more bank accounts in lieu of, or in addition to, creating one or more subledgers within a bank account. For example, the boxes 315a-315f in FIG. 3A may represent separate bank accounts (e.g., one or more checking accounts and/or savings accounts) rather than separate subledgers within a single bank account. In further instances, Josh may have selected and designated or labeled a combination of one or more bank accounts and one or more subledgers within the one or more bank accounts. In addition, the first allocation strategy 340 may be applied to one or more bank accounts rather than one or more subledgers. In other instances, the first allocation strategy 340 may be applied to a combination of one or more bank accounts and one or more subledgers within the one or more bank accounts. Likewise, the second allocation strategy 345 may be applied to one or more bank accounts or a combination of one or more bank accounts and one or more subledgers within the one or more bank accounts.

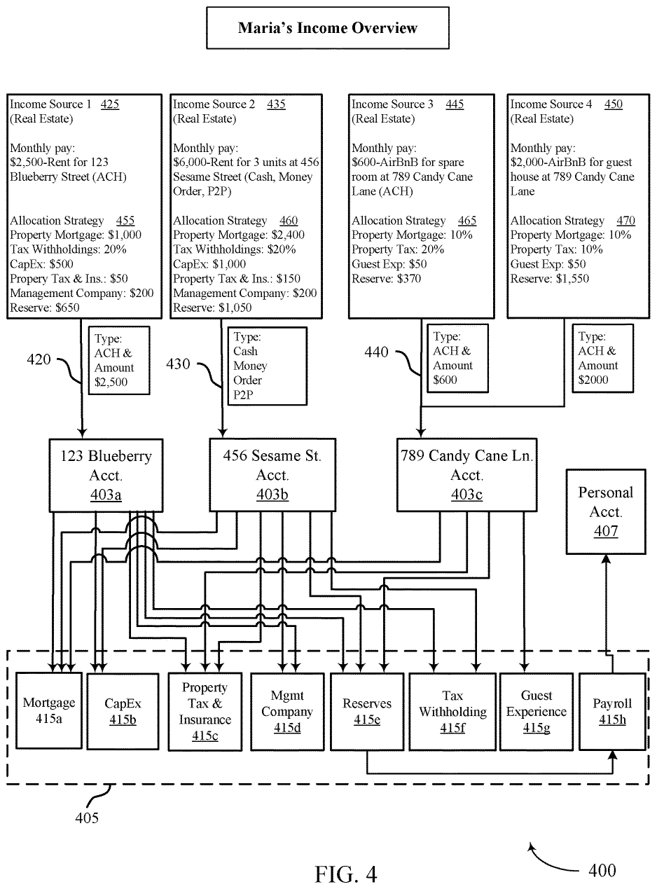

Turning to FIG. 4, a financial allocation strategy 400 for a user (e.g., user 140) is depicted. For ease of reference, the allocation strategy shown in FIG. 4 may be for a user having the name Maria. The financial allocation strategy 340 may be performed or implemented, all or in part, by the system 100 of FIG. 1, the allocation system 700 of FIG. 7, the computer system 1100 of FIG. 11, the context awareness engine 800 of FIG. 8, the behavioral economics module 900 of FIG. 9, and/or by one or more computing devices or components (e.g., one or more AI agents) of such systems, engines, or modules.

Maria may have one or more bank accounts 403 (e.g., 403a, 403b, 403c; collectively referred to as bank accounts 403), 405, and 407 with one or more banks (e.g., financial institution 105). The one or more bank accounts 403, 405, and 407 may be a checking account, a savings account, a credit card account, or a merchant services account. In the example shown in FIG. 4, a bank account 403a may be provided in the form of a business savings account for a first source 425, a bank account 403b may be provided in the form of a business savings account for a second source 435, and a bank account 403c may be provided in the form of a business savings account for a third source 445 and/or a fourth source 450. In addition, in the example shown in FIG. 4, the bank account 405 may be provided in the form of a business checking account that may be used to manage income received from the first, second, third, and fourth sources. Furthermore, the bank account 407 may be provided in the form of a personal checking or savings account.

In the example of FIG. 4, the first source 425, the second source 435, the third source 445, and/or the fourth source 450 may be a real estate property. In some instances, the real estate property may be a single-family home, a condo unit or building, an apartment unit or building, commercial real-estate, a duplex, a room in a house or other unit, a guest room or house a vacation property, a lot, a campground, and the like.

Maria may have selected or created one or more subledgers 415 (e.g., 415a, 415b, 415c, 415d, 415e, 415f, 415g, 415h; collectively referred to as “subledgers 415”), in the bank account 405. The one or more subledgers 415 may include a label, name, or other indicator. In some instances, Maria may have selected the one or more subledgers 415 from a menu of pre-defined subledgers provided by the bank or AI agent. In other instances, Maria may have created or generated the one or more subledgers 415 using a subledger creation tool or module provided by the bank or another entity. In further instances, the one or more subledgers 415 may be a combination of pre-defined subledgers or user-generated subledgers.

As shown in FIG. 4, Maria's bank account 405 may have eight subledgers. Although eight subledgers are shown, the bank account 405 may have zero subledgers or any number of subledgers 415. As shown in FIG. 4, in some instances, the subledgers 415 may include and be labeled as follows: “Mortgage” 415a, “CapEx” 415b, “Property Tax & Insurance” 415c, “Mgmt Company” 415d, “Reserves” 415e, “Tax Withholding” 415f, “Guest Experience” 415g, and “Payroll” 415h. In some instances, the “Reserves” subledger 415e may not be a subledger but rather the general bank account 405.

Maria may have a first income stream 420 coming from the first source 425, which may be a real estate property. In some instances, the first source 425 is a single-family home. Maria may receive income from the first source 425 at a regular interval (e.g., weekly, twice a month, monthly, etc.) or irregular intervals via a type of deposit or transaction (e.g., ACH, cash, check, cashier's check, money order, P2P payment, etc.). In the example shown in FIG. 4, the first source 425 may be a property located at 123 Blueberry Street. Maria may receive income from the first source 425 provided in the form of rent that is received monthly. For example, Maria may receive rent in the amount of $2500 sent via ACH, and the rent may be deposited into the bank account 403a. In some instances, Maria may receive a cash, check, cashier's check, money order, or P2P payment for the monthly rent, which she may deposit into the bank account 403a manually (e.g., via an ATM, bank teller, or an application on Maria's user device).

Maria may have a second income stream 430 coming from the second source 435, which may be a real estate property. In some instances, the second source 435 is a duplex, condominium or apartment building having one or more units. Maria may receive income from the second source 435 at a regular interval (e.g., weekly, twice a month, monthly, etc.) or irregular intervals via a type of deposit or transaction (e.g., ACH, cash, check, money order, P2P payment, etc.). In the example shown in FIG. 4, the second source 435 may be a property located at 456 Sesame Street having three units. Maria may receive income from the second source 435 provided in the form of rent that is received monthly. For example, Maria may receive rent in the amount of $6000 for the three units sent via cash, check, cashier's check, money order, or P2P payment. In some instances, Maria may deposit the rent into the bank account 403b manually (e.g., via an ATM, bank teller, or an application on Maria's user device) or the rent may be deposited automatically, for example, via a P2P payment application. In other instances, Maria may receive payment via ACH for the monthly rent, which is automatically deposited into the bank account 403b.

Maria may have a third income stream 440 coming from the third source 445 and a fourth source 450, which may each be a real estate property that is offered on a home share application. In some instances, the third source 445 and the fourth source 450 may be located on or in the same property. In other instances, the third source 445 and the fourth source 450 may be located on or in different properties. Maria may receive income from the third source 445 and/or the fourth source 450 at regular intervals (e.g., weekly, twice a month, monthly, etc.) or irregular intervals via a type of deposit or transaction (e.g., ACH, cash, check, money order, P2P payment, etc.). In the example shown in FIG. 4, the third source 445 may be a room at a property located at 789 Candy Cane Lane, and the fourth source 450 may be a guest house located at 789 Candy Cane Lane. Maria may receive income from the third source 445 and the fourth source 450 provided in the form of payments that are received monthly via the home share application. For example, with respect to the third source 445, Maria may receive payment in the amount of $600 for the room sent via ACH; and, with respect to the fourth source 450, Maria may receive payment in the amount of $2000 for the guest house sent via ACH. The ACH payments received from the third source 445 and fourth source 450 may be deposited into the bank account 403b. In some instances, Maria may receive a cash, check, cashier's check, money order, or P2P payment as payment for the room or guest house, which she may deposit into the bank account 403b manually (e.g., via an ATM, bank teller, or an application on Maria's user device) or may be deposited automatically, for example, via a P2P payment application.

As shown in FIG. 4, Maria may decide to allocate all or a portion of the first income stream 420, all or a portion of the second income stream 430, and/or all or a portion of the third income stream 440 into the one or more subledgers 415. The one or more subledgers 415 that Maria selects to allocate funds from the first income stream 420, the second income stream 430, and/or the third income stream 440 may be the same or different.

As shown in FIG. 4, a first allocation strategy 455 may be used for the first income stream 420 that has been deposited into the bank account 403a. In some instances, the user (e.g., Maria) may define the first allocation strategy 455; and in other instances, one or more AI agents, as discussed herein, may define the first allocation strategy 455. The first allocation strategy 455 may allocate one or more specific amounts and/or one or more percentages of the first income stream 420 into the one or more subledgers 415.

In an example, the first allocation strategy 455 may divide the first income stream 420 into five specific amounts (e.g., $1000, $500, $50, $200, and $650) and one percentage (e.g., 20%), which may be deposited into six subledgers (e.g., 415a, 415b, 415c, 415d, 415e, and 415f). In other instances, the first income stream 420 may be divided into any number of amounts or percentages or not divided at all. Similarly, the first income stream 420 may be deposited into zero subledgers (e.g., deposited into the general bank account 405) or any number of subledgers. In the example depicted in FIG. 4, Maria has allocated set amounts and a percentage of the first income stream 420 (e.g., the $2500 rent) received from the first source 425. For example, Maria may allocate $1000 of the first income stream 420 for property mortgage payments into the subledger 415a labeled “Mortgage”, $500 of the first income stream 420 for capital expenditures into the subledger 415b labeled “CapEx”, $50 of the first income stream 420 for property taxes and/or property insurance into the subledger 415c labeled “Property Tax & Insurance”, $200 of the first income stream 420 for management company service fees into the subledger 415d labeled “Mgmt Company”, and $650 of the first income stream 420 for other expenses into the subledger 415e labeled “Reserves”. Maria may also allocate 20% of the first income stream 420, or $500 (0.20×$2500), for tax withholdings in the subledger 415f labeled “Tax Withholdings”.

As shown in FIG. 4, a second allocation strategy 460 may be used for the second income stream 430 that has been deposited into the bank account 403b. In some instances, the user (e.g., Maria) may define the second allocation strategy 460; and in other instances, one or more AI agents, as discussed herein, may define the second allocation strategy 460. The second allocation strategy 460 may allocate one or more specific amounts and/or one or more percentages of the second income stream 430 into the one or more subledgers 415.

In an example, the second allocation strategy 460 may divide the first income stream 420 into five specific amounts (e.g., $2400, $1000, $150, $200, and $1050) and one percentage (e.g., 20%), which may be deposited into six subledgers (e.g., 415a, 415b, 415c, 415d, 415e, and 415f). In other instances, the second income stream 430 may be divided into any number of amounts or percentages or not divided at all. Similarly, the second income stream 430 may be deposited into zero subledgers (e.g., deposited into the general bank account 405) or any number of subledgers. In the example depicted in FIG. 4, Maria has allocated set amounts and a percentage of the first income stream 420 (e.g., the $6000 in rent) received from the second source 435. For example, Maria may allocate $2400 of the second income stream 430 for property mortgage payments into the subledger 415a labeled “Mortgage”, $1000 of the second income stream 430 for capital expenditures into the subledger 415b labeled “CapEx”, $150 of the second income stream 430 for property taxes and/or property insurance into the subledger 415c labeled “Property Tax & Insurance”, $200 of the second income stream 430 for management company service fees into the subledger 415d labeled “Mgmt Company”, and $1050 of the first income stream 420 for other expenses into the subledger 415e labeled “Reserves”. Maria may also allocate 20% of the first income stream 420, or $1200 (0.25×$6000), for tax withholdings in the subledger 415f labeled “Tax Withholdings”.

As shown in FIG. 4, a third allocation strategy 465 and a fourth allocation strategy 470 may be used for the third source 445 and the fourth source 450, respectively, which have been deposited into the bank account 403c as the third income stream 440. In some instances, the user (e.g., Maria) may define the third allocation strategy 465 and/or the fourth allocation strategy 470; and in other instances, one or more AI agents, as discussed herein, may define the third allocation strategy 465 and/or the fourth allocation strategy 470. The third allocation strategy 465 and/or the fourth allocation strategy 470 may allocate one or more specific amounts and/or one or more percentages of the third income stream 440 into the one or more subledgers 415.

In an example, the third allocation strategy 465 may divide the income received from the third source 445 into two specific amounts (e.g., $50 and $370) and two percentages (e.g., 10% and 20%), which may be deposited into four subledgers (e.g., 415a, 415c, 415e, and 415g). In other instances, the income received from the third source 445 may be divided into any number of amounts or percentages or not divided at all. Similarly, the income from the third source 445 may be deposited into zero subledgers (e.g., deposited into the general bank account 405) or any number of subledgers.

In the example depicted in FIG. 4, Maria has allocated set amounts and percentages of the third source 445 (e.g., the $600 payment). For example, Maria may allocate 10%, or $60 (e.g., 10%×$600), of the third source 445 for property mortgage payments into the subledger 415a labeled “Mortgage”, 20%, or $120 (e.g., 20%×$600), of the third income source 445 for property taxes and/or property insurance into the subledger 415c labeled “Property Tax & Insurance”, $50 of the third source 445 for guest experiences into the subledger 415g labeled “Guest Experience”, and $370 of the third source 445 for other expenses into the subledger 415e labeled “Reserves”.

As shown in FIG. 4, the fourth allocation strategy 470 may divide the income received from the fourth source 450 into two specific amounts (e.g., $50 and $1550) and two percentages (e.g., 10% and 10%), which may be deposited into four subledgers (e.g., 415a, 415c, 415e, and 415g). In other instances, the income received from the fourth source 450 may be divided into any number of amounts or percentages or not divided at all. Similarly, the income from the fourth source 450 may be deposited into zero subledgers (e.g., deposited into the general bank account 405) or any number of subledgers.

In the example depicted in FIG. 4, Maria has allocated set amounts and percentages of the fourth source 450 (e.g., the $2000 payment). For example, Maria may allocate 10%, or $200 (e.g., 10%×$2000), of the fourth source 450 for property mortgage payments into the subledger 415a labeled “Mortgage”, 10%, or $200 (e.g., 20%×$2000), of the third source 445 for property taxes and/or property insurance into the subledger 415c labeled “Property Tax & Insurance”, $50 of the fourth source 450 for guest experiences into the subledger 415g labeled “Guest Experience”, and $1550 of the fourth source 450 for other expenses into the subledger 415e labeled “Reserves”.

In some instances, the one or more of the subledgers 415 may have an allocation strategy in which some or all of the funds in the one or more subledgers 415 may be deposited into another subledger or another bank account. For example, as shown in the example of FIG. 4 the “Reserves” subledger 415e may allocate all or some of the funds received from the bank accounts 403 into another subledger, e.g., the “Payroll” subledger 415h. In some instances, all or a portion of the funds deposited in the “Payroll” subledger 415h may be deposited into the personal bank account 407.

In the example depicted in FIG. 4, Maria has allocated set amounts and percentages of the income from the third source 445 (e.g., the $6000 in rent) into multiple subledgers. For example, Maria may allocate $2400 of the third source 445 for property mortgage payments into the subledger 415a labeled “Mortgage”, $1000 of the third source 445 for capital expenditures into the subledger 415b labeled “CapEx”, $150 of the third source 445 for property taxes and/or property insurance into the subledger 415c labeled “Property Tax & Insurance”, $200 of the third source 445 for management company service fees into the subledger 415d labeled “Mgmt Company”, and $1050 of the third source 445 for other expenses into the subledger 415e labeled “Reserves”. Maria may also allocate 20% of the third source 445, or $1200 (0.25×$6000), for tax withholdings in the subledger 415f labeled “Tax Withholdings”.

In some instances, the user (e.g., Maria) may have selected and designated or labeled one or more bank accounts in lieu of, or in addition to, creating one or more subledgers within a bank account. For example, the boxes 415a-415h in FIG. 4 may represent separate bank accounts (e.g., one or more checking accounts and/or savings accounts) rather than separate subledgers within a single bank account. In further instances, Maria may have selected and designated or labeled a combination of one or more bank accounts and one or more subledgers within the one or more bank accounts. In addition, the first allocation strategy 455 may be applied to one or more bank accounts rather than one or more subledgers. In other instances, the first allocation strategy 455 may be applied to a combination of one or more bank accounts and one or more subledgers within the one or more bank accounts. Likewise, the second allocation strategy 460 may be applied to one or more bank accounts or a combination of one or more bank accounts and one or more subledgers within the one or more bank accounts. Similarly, the third and fourth allocation strategies 465 and 470, respectively, may be applied to one or more bank accounts or a combination of one or more bank accounts and one or more subledgers within the one or more bank accounts.

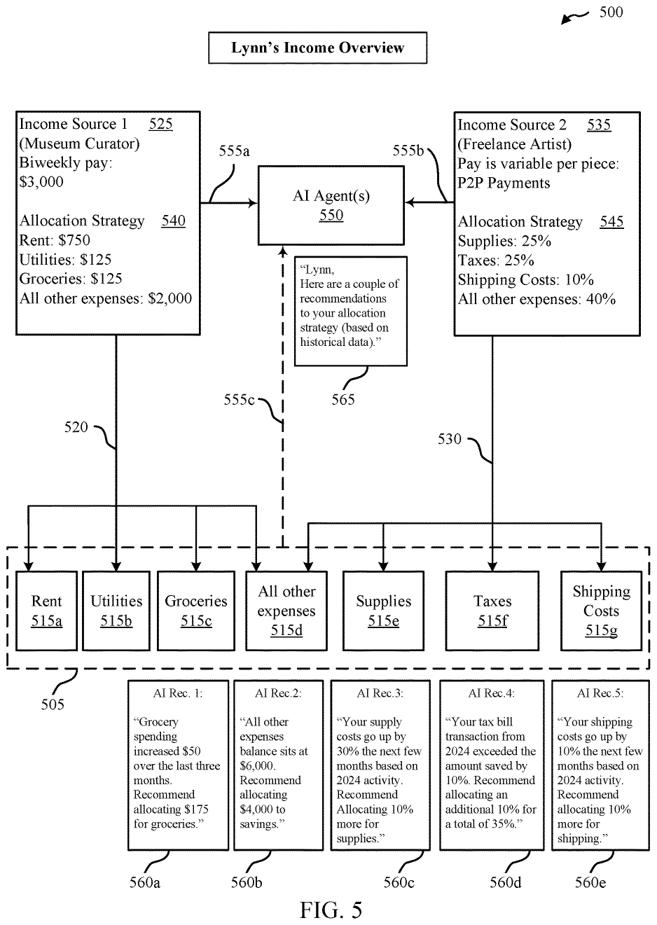

Turning to FIG. 5, an example financial allocation strategy 500 for a user (e.g., user 140) is depicted. For ease of reference, the allocation strategy shown in FIG. 5 may be for a user having the name Lynn. The financial allocation strategy 500 may include the use of one or more AI agents 550. The financial allocation strategy 500 may be performed or implemented, all or in part, by the system 100 of FIG. 1, the allocation system 700 of FIG. 7, the computer system 1100 of FIG. 11, the context awareness engine 800 of FIG. 8, the behavioral economics module 900 of FIG. 9, and/or by one or more computing devices or components (e.g., one or more AI agents) of such systems, engines, or modules.

Lynn may have a bank account 505 with a bank (e.g., financial institution 105). The bank account 505 may be a checking account or a savings account. In the example shown in FIG. 5, the bank account 505 is provided in the form of a checking account.

Lynn may have selected or created one or more subledgers 515 in the bank account 505. The subledgers 515 may include a label, name, or other indicator. In some instances, Lynn may have selected the one or more subledgers 515 from a menu of pre-defined subledgers provided by the bank or generated by the one or more AI agents 550. In other instances, Lynn may have created the one or more of her own subledgers 515 from a subledger creation tool or module provided by the bank, the one or more AI agents 550, or other entity. In further instances, the one or more subledgers 515 may be a combination of pre-defined subledgers or user-generated subledgers.

As shown in FIG. 5, Lynn's bank account 505 may have seven subledgers. Although seven subledgers are shown, the bank account 505 may have zero subledgers or any number of subledgers 515. As shown in FIG. 5, in some instances, the subledgers 515 may include and be labeled as follows: “Rent” 515a, “Utilities” 515b, “Groceries” 515c, “All other expenses” 515d, “Supplies” 515e, “Taxes” 515f, and “Shipping Costs” 315g. In some instances, the “All other expenses” subledger 515d may not be a separate subledger but rather the general bank account 505.

Lynn may have a first income stream 520 coming from a first source 525. The first source 525 may be a company or organization that has hired Lynn as “W2 employee.” Lynn may receive a paycheck from her employer at a regular interval (e.g., weekly, twice a month, monthly, etc.) or irregular intervals. In the example shown in FIG. 5, Lynn's employer may be a museum, the interval at which Lynn may receive a paycheck may be bi-weekly (i.e., twice a month), and the amount of each paycheck may be $3000. Lynn may deposit the paycheck into her bank account 505 manually (e.g., via an ATM, bank teller, or an application on Lynn's user device) or the first source 525 may pay Lynn via direct deposit with Lynn's bank.

Lynn may also have a second income stream 530 coming from a second source 535. The second source 535 may be a side job or hobby. In the example, shown in FIG. 5, Lynn's second source 535 of income may be from her work as a freelance artist. Lynn may receive payments from purchasers of her work via a P2P payment application at the same or different interval as the first source 525. In some instances, Lynn may only receive payment when one of her works is purchased. Thus, Lynn's income stream 530 from the second source 535 may be sporadic and not received on regular intervals or for regular amounts (e.g., the works Lynn creates may be variably priced).

As shown in FIG. 5, Lynn may decide to allocate all or a portion of the first income stream 520 into the one or more subledgers 515. Likewise, Lynn may decide to allocate all or portion of the second income stream 530 into the one or more subledgers 515. The one or more subledgers 515 that Lynn selects to allocate funds from the first income stream 520 may be the same or different than the one or more subledgers 515 that Lynn selects to allocate the funds from the second income stream 530.

As provided in FIG. 5, a first allocation strategy 540 may be implemented by Lynn for the first income stream 520. In some instances, the user (e.g., Lynn) may define the first allocation strategy 540; and in other instances, the one or more AI agents 550, as discussed herein, may define the first allocation strategy 540. The first allocation strategy 540 may allocate one or more specific amounts or one or more percentages of the first income stream 520 into the one or more subledgers 515. In an example, the first allocation strategy 540 may divide the first income stream 520 into four amounts (e.g., $750, $125, $125, and $2000), which may be deposited into four subledgers (e.g., 515a, 515b, 515c, and 515d). In the example of FIG. 5, Lynn has allocated a set amount of the first income stream 520 (e.g., the $3000 paycheck) received from the first source 525 into four subledgers. For example, Lynn may allocate $750 of the first income stream 520 into the “Rent” subledger 515a, $125 of the first income stream 520 into the “Utilities” subledger 315b, $125 of the first income stream 520 into the “Groceries” subledger 315c, and $2000 of the first income stream 520 into the “All other expenses” subledger 515d.

Lynn may likewise implement a second allocation strategy 545 for the second income stream 530. In some instances, the user (e.g., Lynn) may define the second allocation strategy 545; and in other instances, the one or more AI agents 550, as discussed herein, may define the second allocation strategy 545. The second allocations strategy 545 may allocate one or more specific amounts or one or more percentages of the second income stream 530 into the one or more subledgers 315.

In an example, the second allocation strategy 545 may divide the second income stream 530 into four percentages (e.g., 25%, 25%, 10%, and 40%), and the amounts associated with the four percentages may be deposited into four subledgers (e.g., 515d, 515e, 515f, and 515g). In the example of FIG. 5, Lynn may allocate a set percentage of the second income stream 530 received from the second source 535. For example, Lynn may allocate 25% of the second income stream 530 for art supplies into the subledger 515e labeled “Supplies”, 25% of the second income stream 530 for taxes into the subledger 515f labeled “Taxes”, 10% of the second income stream 530 for shipping supplies and costs into the subledger 515g labeled “Shipping Costs”, and 40% of the second income stream 530 for other expenses into the subledger 515d labeled “All other expenses”.

In some instances, the user (e.g., Lynn) may have selected and designated or labeled one or more bank accounts in lieu of, or in addition to, creating one or more subledgers within a bank account. For example, the boxes 515a-515g in FIG. 5A may represent separate bank accounts (e.g., one or more checking accounts and/or savings accounts) rather than separate subledgers within a single bank account. In further instances, Lynn may have selected and designated or labeled a combination of one or more bank accounts and one or more subledgers within the one or more bank accounts. In addition, the first allocation strategy 540 may be applied to one or more bank accounts rather than one or more subledgers. In other instances, the first allocation strategy 540 may be applied to a combination of one or more bank accounts and one or more subledgers within the one or more bank accounts. Likewise, the second allocation strategy 545 may be applied to one or more bank accounts or a combination of one or more bank accounts and one or more subledgers within the one or more bank accounts.

In some instances, the financial allocation strategy 500 may incorporate or use the one or more AI agents 550. The one or more AI agents 550 may be a tool provided though the bank or another entity. In some instances, the user (e.g., Lynn) may opt into the use of the one or more AI agents 550; and, in other instances, the user may opt out of the use of the one or more AI agents 550.

The one or more AI agents 550 may receive data 555 (e.g., 555a, 555b, and 555c; collectively referred to as data 555), relating to the one or more income streams. The data 555 may include a name or other identifying information for the income source, a number of bank accounts, a number of subledgers in the bank accounts, the name or other identifying information of the one or more bank accounts and/or the one or more subledgers within the one or more bank accounts, any allocation strategies for the income streams, expenses paid or debit transactions made using funds deposited in the one or more bank accounts and/or the one or more subledgers, among other information, including any of the parameters described herein. In some instances, the data 555 may also include the amount of the deposit, a deposit date, a deposit time, type of deposit or transaction received from the source (e.g., ACH, cash, check, cashier's check, money order, P2P payment, etc.), deposit amount frequency, deposit amount variability, and/or deposit amount consistency. For example, the data 555 received by the one or more AI agent 550 may include the amount of the income received from a source and the interval at which the income is received from the source as well as the name and number of any selected bank accounts or subledgers within the bank account and the set amounts or percentages of the income being allocated to each of the selected bank accounts and/or subledgers. The one or more AI agent 550 may also receive information regarding the amount, date, and time of expenses paid using the one or more bank accounts or subledgers as well as the one or more bank accounts or subledgers from which the expense are paid.

As shown in FIG. 5, the one or more AI agents 550 may receive data 555a. Data 555a may include the name of the first source 525 (e.g., museum), the amount of the first income source (e.g., $3000), and the interval for the first source 525 (e.g., biweekly). The data 555a may also include information about the first allocation strategy 540. For example, the name of the bank accounts or subledgers selected (e.g., “Rent”, “Utilities”, “Groceries”, and “All other expenses”) and the amounts of the first income stream 520 that are being deposited into each of the selected bank accounts or subledgers (e.g., $750, $125, $115, and $2000, respectively). The one or more AI agent 550 may also receive data 555b. Data 555b may include the name of the second income source 535 (e.g., freelance), the amount of the second income source, and the interval for the second income source 535 (e.g., variable or inconsistent). The data 555b may also include information about the second allocation strategy 545. For example, the name or indicator of the bank accounts or subledgers selected (e.g., “Supplies”, “Taxes”, “Shipping Costs”, and “All other expenses”) and the percentages of the second income stream 530 that are being deposited into each of the selected bank accounts or subledgers (e.g., $25%, 25%, 10%, and 40%, respectively). The one or more AI agents 550 may also receive data 555c. Data 555c may be information relating to the expenses paid using the bank account 505 or other bank accounts. For example, data 555c may include the amounts paid out of each bank account or subledger, the date and time of the payments, the name of the merchant or payee, the merchant type or MCC, and the like.

The one or more AI agents 550 may use the data 555 received for the user (e.g., Lynn) and provide one or more recommendations 560a through 560e (collectively referred to as “recommendations 560”). The one or more AI agents 550 may output a notification 565 to the user and may initiate conversation with the user before a recommendation 560 is presented. In some instances, the notification 565 may be provided in the form of a pop-window on the screen that a user is using to view their bank account information. The one or more recommendations 560 may also be presented in the same pop-window as the notification 565 or may be presented in different pop-up windows or screens. In some instances, the user may consider the one or more recommendations 560, accept one or more of the recommendations 560, ignore the recommendations 560, or exit out of a window showing the notification 565 or any other pop-up window relating to the AI agent 550 or the AI agent's recommendations 560. As shown in FIG. 5, the notification 565 may state, for example: “Lynn, here are a couple of recommendations to your allocation strategy (based on historical data).”

In some instances, the one or more recommendations 560 may be specific to a particular bank account or subledger 515 and may include information about the data 555 received. For example, as shown in FIG. 5, the one or more AI agents 550 may provide five recommendations 560a, 560b, 560c, 560d, and 560e. The first recommendation 560a may relate to the “Groceries” bank account or subledger 515c. For example, the first recommendation 560a may indicate: “Grocery spending increased $50 over the last three months. Recommend allocating $175 for groceries.” The user (e.g., Lynn) may consider the first recommendation 560a, accept, reject, or ignore the first recommendation 560a, or exit out of the notification 565 or any other window associated with the AI agent 550. If Lynn accepts the first recommendation 560a, then the first allocation strategy 540 may be updated so that $175 is being deposited in the “Groceries” bank account or subledger 515c, rather than $125. In addition, the first allocation strategy 540 may be updated such that at least one of the other allocation amounts is reduced by the amount that the “Groceries” bank account or subledger 515c is increased (e.g., the allocation to the “All other expenses” bank account or subledger 515d may be reduced by $50 for a total of $1950, rather than $2000) so that the total amount of money being allocated into the selected bank accounts or subledgers does not exceed the first income stream 520. In some cases, the amount of the decrease may be spread across more than one bank account or subledger (e.g., the amount allocated for the “Utilities” bank account or subledger 515b may be reduced from $125 to $100 and the amount allocated to the “All other expenses” bank account or subledger 515d may be reduced from $2000 to $1975). In some instances, the first allocation strategy 540 may be automatically updated. In other instances, the user may adjust the amounts allocated to one or more of the bank accounts or subledgers 515. The AI agent 550 may present to the user a suggestion of which bank accounts or subledgers may have reduced allocations, and the user may select which subledgers from the suggested bank accounts or subledgers to receive reduced allocations.

In some examples, the AI agent 550 may provide information to the user related to details of how a budget was exceeded. In some examples, the AI agent 550 may prompt the user for information on any changes that may have caused the budget to be exceeded (e.g., the user may adjust a number of people in the household who are using groceries, an address change of the user, a shopping preference change, a dietary change of someone in the household, etc.). The AI agent 550 may use this information to recommend a budget adjustment for the particular bank account or subledger. Further, in some examples, the AI agent 550 may determine that the budget was exceeded based on factors outside of the user's control, such as a change in the consumer price index or the like. The AI agent 550 may correlate this information with the budgets, goals, and subledgers and/or bank accounts designated by the user to provide the one or more recommendations 560.

In the example of FIG. 5, a second recommendation 560b may relate to the All other expenses bank account or subledger 515d. For example, the second recommendation 560b may indicate: “All other expenses balance sits at $6,000. Recommend allocating $4,000 to savings.” Lynn may consider the second recommendation 560b, and accept, reject, or ignore the second recommendation 560b, or exit out of the notification 565 or any other window associated with the AI agent 550. If Lynn accepts the second recommendation 560b, then Lynn may be requested to link her bank account 505 to a savings account at the bank (or another financial institution) or create a new subledger in the bank account 505 and label the new subledger “Savings”. In some examples, the AI agent 550 may initiate the transaction by sending one or more signals indicating the transaction to the respective financial institutions.

As shown in FIG. 5, a third recommendation 560c may relate to the “Supplies” bank account or subledger 515e. For example, the third recommendation 560c may indicate: “Your supply costs go up by 30% the next few months based on 2024 activity. Recommend Allocating 10% more for supplies.” Lynn may consider the third recommendation 560c, and accept, reject, or ignore the third recommendation 560c, or exit out of the notification 565 or any other window associated with the AI agent 550. If Lynn accepts the third recommendation 560c, then the AI agent 550 may update the second allocation strategy 545 so that 35% of the second income stream 530 is being deposited in the “Supplies” bank account or subledger 515e, rather than 25%. In addition, the second allocation strategy 545 may be updated such that at least one of the other allocation percentages is reduced by the amount that the “Supplies” bank account or subledger 515e is increased (e.g., the percentage of the amount allocated to the “All other expenses” bank account or subledger 515d may be reduced from 40% to 30%) so that the total percentage of the second income stream 530 being allocated does not exceed 100%. In some cases, the amount of the decrease may be spread across more than one bank account or subledger (e.g., the percentage of the amount allocated to the “Taxes” bank account or subledger 515f may be reduced from 25% to 20% and the percentage of amount allocated to the “All other expenses” bank account or subledger 515d may be reduced from 40% to 35%). In some instances, the second allocation strategy 545 may be automatically updated and in other instances, the user may adjust the selected bank accounts or subledgers.

As shown in FIG. 5, a fourth recommendation 560d may relate to the “Taxes” bank account or subledger 515f. For example, the fourth recommendation 560d may indicate: “Your tax bill transaction from 2024 exceeded the amount saved by 10%. Recommend allocating an additional 10% for a total of 35%.” Lynn may consider the fourth recommendation 560d, and accept, reject, or ignore the fourth recommendation 560d, or exit out of the notification 565 or any other window associated with the AI agent 550. If Lynn accepts the fourth recommendation 560d, then the second allocation strategy 545 may update so that 35% of the second income stream 530 is being deposited in the “Taxes” bank account or subledger 515f, rather than 25%. In addition, the second allocation strategy 545 may be updated (either automatically or by the user) such that at least one of the other allocation percentages is reduced by the amount (e.g., 10%) that the “Taxes” bank account or subledger 515f is increased.

As shown in FIG. 5, a fifth recommendation 560e may relate to the “Shipping Costs” bank account or subledger 515g. For example, the fifth recommendation 560e may indicate: “Your shipping costs go up by 10% the next few months based on 2024 activity. Recommend allocating 10% more for shipping.” Lynn may consider the fifth recommendation 560e, and accept, reject, or ignore the fifth recommendation 560e, or exit out of the notification 565 or any other window associated with the AI agent 550. If Lynn accepts the fifth recommendation 560e, then the AI agent 550 may update the second allocation strategy 545 so that 20% of the second income stream 530 is being deposited in the “Shipping Costs” bank account or subledger 515g, rather than 10%. In addition, the second allocation strategy 545 may be updated (either automatically or by the user) such that at least one of the other allocation percentages is reduced by the amount (e.g., 10%) that the “Shipping Costs” bank account or subledger 515g is increased.

In some examples, the one or more recommendations 560 provided by the one or more AI agents 550 may relate to or be based on a type of deposit or transaction received (e.g., ACH, cash, check, cashier's check, money order, P2P payment, etc.). For example, the one or more AI agent 550 may provide a summary of all or a portion of the income Maria is receiving from a certain transaction type and a recommendation relating thereto. For example, the AI agent 550 may indicate: “Last month you received $10,000 in P2P payments from freelance source. Recommend allocating 15% to tax withholdings.”

In some instances, the user may engage with the AI agent 550 by asking questions or prompts. The questions or prompts may be entered into the same pop-up window as the notification 565 or may be presented in a separate pop-up window or screen. The AI agent 550 may respond to the questions or prompts in the same pop-up window as the notification 565 or in additional pop-up windows or screens.

Through the use of the one or more AI agents 550, which may provide one or more recommendations to the user based on analyzing data relating to income received from difference sources (e.g., employer, contract work, real estate, other financial instrument, etc.), the frequency at which the income is received, and/or spending habits of the user, a user may be able to better organize their finances and make more informed financial decisions. In addition, use of the one or more AI agents 550 may also alleviate the mental load associated with organizing and managing finances.

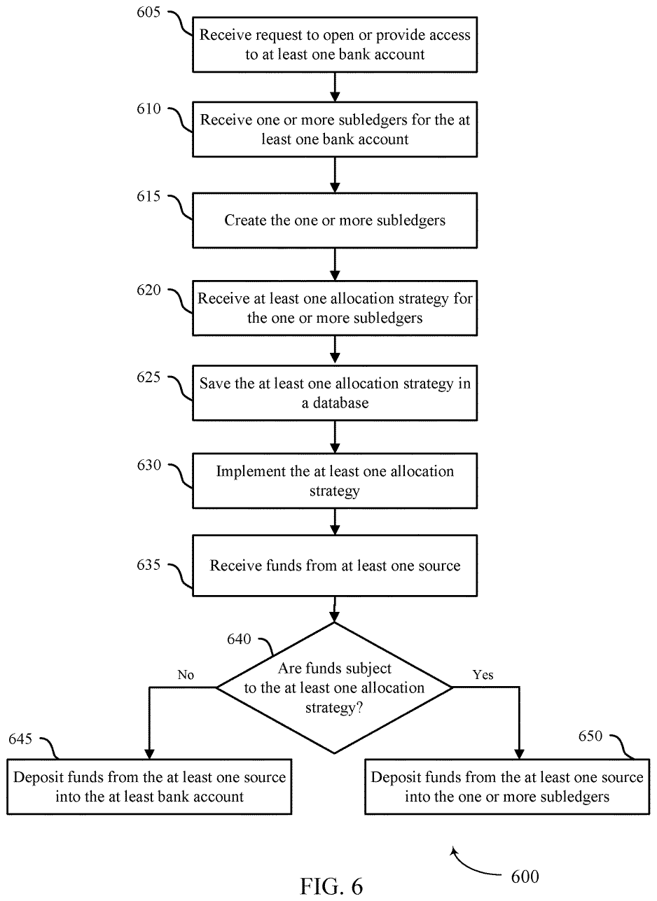

Turning to FIG. 6, a flowchart of an example method 600 is provided. The method 600 may illustrate a method of depositing monetary funds into at least one bank account having one or more subledgers is illustrated. In some instances, the example method 600 may be for depositing monetary funds into one or more bank accounts rather than one or more subledgers. In other instances, the example method 600 may be for depositing monetary funds into one or more bank accounts and/or one or more subledgers. In some examples, the at least one bank account may be, or include aspects of, the one or more bank accounts 130 of FIG. 1, the one or more bank accounts 305 of FIG. 3, the one or more bank accounts 403 of FIG. 4, and/or the one or more bank accounts 505 of FIG. 5; and, the one or more subledgers may be, or include aspects of, the one or more subledgers 135 of FIG. 1, the one or more subledgers 315 of FIG. 3, the one or more subledgers 415 of FIG. 4, and/or the one or more subledgers 515 of FIG. 5. Furthermore, the method 600 may be performed or implemented all, or in part, by the system 100 of FIG. 1, the allocation system 700 of FIG. 7, the context awareness engine 800 of FIG. 8, the behavioral economics module 900 of FIG. 9, the computer system 1100 of FIG. 11, and/or by one or more computing devices or components of such systems, engines, or modules (e.g., one or more AI agents).

At 605, a bank or other financial institution (e.g., the financial institution 105 of FIG. 1), may receive a request from a user to open at least one new bank account and/or to provide the user with access to at least one existing bank account at the bank. In some instances, a user may request the bank to open a joint bank account with one or more other users.

At 610 one or more subledgers for the at least one bank account may be received. In some instances, a user may select one or more pre-defined subledgers. For example, a user may select one or more subledgers from a drop-down menu on a mobile application or website associated with the bank and that may be used to open or access the at least one bank account or a user may select one or more subledgers provided or suggested by one or more AI agents. In other instances, a user may generate their own one or more subledgers. For example, a user may define one or more user-generated subledgers using a subledger generation tool provided by the bank via a mobile application or website or via one or more AI agents. In other instances, a user may select a combination of one or more pre-defined subledgers and one or more user-generated subledgers. If a user does not select one or more subledgers (either one or more pre-defined subledgers or one or more user-generated subledgers), then the bank may open or access a general bank account. In other instances, a dashboard may be provided to the user for selecting or identifying the subledgers.

At 615, the one or more subledgers selected or provided by the user may be created. In some instances, the one or more subledgers may be created by the bank or via one or more AI agents. Once the one or more subledgers are created, they may become viewable on the mobile application or website used to access the at least one bank account.

At 620, at least one allocation strategy for the one or more subledgers may be received or provided. In some instances, a user may select or create the at least one allocation strategy and, in other instances, the at least one allocation strategy may be generated or provided by one or more AI agents. For example, the at least one allocation strategy may indicate that a first percentage of one or more income streams may be deposited into a first subledger, a second percentage of the one or more income streams may be deposited into a second subledger, and so on, and that any remainder of the one or more income streams may be deposited into the at least one bank account. In other instances, the at least one allocation strategy may indicate that a first dollar amount of one or more income streams may be deposited into the first subledger, a second dollar amount of the one or more income streams may be deposited into the second subledger, and so on, and that any remainder of the one or more income streams may be deposited into the at least one bank account. In further instances, the at least one allocation strategy may indicate that a percentage of the one or more income streams may be deposited into a first subledger, a set dollar amount of the one or more income streams may be deposited into a second subledger, or vice versa, and any remainder of the one or more income streams may be deposited into the at least one bank account. In further instances, the at least one allocation strategy may allocate a portion or all of an income stream into a different checking or savings account or allocate all or a portion of an income stream to a credit card account. In some instances, a dashboard, which may be the same or different from the dashboard provided for subledger generation, may be provided to the user to enable the user to create the at least one allocation strategy.

In some examples, if the at least one bank account is a joint account, only one user may be able to create or select subledgers and/or allocation strategies. In other instances, any of the users of the joint account may create or select subledgers and/or allocation strategies. In further examples, a user may merge subledgers and/or allocation strategies from an existing bank account into a new bank account for the user or into a joint account.

At 625, the at least one allocation strategy may be saved in one or more databases (e.g., the at least one database 115 of FIG. 1).

At 630, the at least one allocation strategy for the one or more subledgers may be implemented. In some instances, the at least one allocation strategy may be implemented by the bank or other financial institution or via one or more AI agents.

At 635, monetary funds from at least one source may be received. In some instances, the monetary funds may be provided in the form of an ACH transfer, money order, check or cash deposit, P2P payment, or the like. In some examples, the at least one source may be, or include aspects of, the one or more sources 120 of FIG. 1, the first and/or the second income source 325 or 335, respectively, of FIG. 3, the first, second, third, and/or fourth income sources 425, 435, 445, or 450, respectively, of FIG. 4, and/or the first and/or the second income source 525 or 535, respectively, of FIG. 5.

At 640, the monetary funds may be evaluated to determine if they are subject to the at least one allocation strategy. In some examples, the evaluation may be performed by the bank via one or more AI agents. If the received monetary funds are not subject to the at least one allocation strategy, then the monetary funds may be deposited into the at least one bank account at 645. If the received monetary funds are subject to the at least one allocation strategy, then the monetary funds or a portion thereof may be deposited into the one or more subledgers at 650. For example, the monetary funds may be a first income stream for which an allocation strategy has been developed. The bank (or AI agents), at 650, may therefore deposit one or more percentages or one or more set dollar amounts of the first income stream into the one or more subledgers based on the at least one allocation strategy. In other instances, the monetary funds may be from an income stream for which no allocation strategy has been developed. In this example, at 645, the monetary funds may be deposited into the at least one bank account and not into the one or more subledgers. The method may then end.

FIG. 7 depicts a block diagram of an example allocation system 700. In some instances, the allocation system 700 may include one or more AI agents to assist in the preparation of one or more allocation strategies and/or the allocation of funds into at least one bank account and/or one or more subledgers of the at least one bank account. In some examples, the at least one bank account may be, or include aspects of, the one or more bank accounts 130 of FIG. 1, the one or more bank accounts 305 of FIG. 3, the one or more bank accounts 403 of FIG. 4, and/or the one or more bank accounts 505 of FIG. 5; and, the one or more subledgers may be, or include aspects of, the one or more subledgers 135 of FIG. 1, the one or more subledgers 315 of FIG. 3, the one or more subledgers 415 of FIG. 4, and/or the one or more subledgers 515 of FIG. 5. The allocation system 700 may include one or more inputs, outputs, components, engines, or modules, and/or provide one or more functions.

At 705, a deposit event and/or a data event (hereinafter referred to as “deposit/data event”) may occur. In some aspects, the deposit/data event may be the receipt of one or more incoming monetary funds from at least one source into the at least one bank account (e.g., a payroll deposit, money transfer, cash or check deposit, etc.). In some examples, the at least one source may be, or include aspects of, the one or more sources 120 of FIG. 1, the first and/or the second income source 325 or 335, respectively, of FIG. 3, the first, second, third, and/or fourth income sources 425, 435, 445, or 450, respectively, of FIG. 4, and/or the first and/or the second income source 525 or 535, respectively, of FIG. 5.

In some aspects, the deposit/data event may be the receipt of data. In some instances, the data may relate to, or otherwise be associated with, the monetary funds received and/or the data may relate to, or otherwise be associated with, a user of the at least one bank account including, for example, how the user uses the monetary funds. In some examples, the data may be, or include aspects of, of data 555 of FIG. 5. The deposit/data event may trigger an allocation process within the allocation system 700.

At least one AI agent 710 of the allocation system 700 may receive the deposit/data event. In some aspects, the at least one AI agent 710 may act as the brain or central controller of the allocation system 700 and may coordinate all engines and/or modules within or associated with the at least one AI agent 710 and/or manage the flow of data through the allocation system 700. In some aspects, the at least one AI agent 710 may receive the one or more deposit/data events and determine which engines or modules to activate for optimal allocation of monetary funds. For example, the at least one AI agent 710 may determine if all or a portion of the data received should be provided to a contextual awareness engine 715, a behavioral economics module 720, and/or a security and compliance module 725 of the allocation system 700.

The contextual awareness engine 715 may receive data from the at least one AI agent 710. In some aspects, the contextual awareness engine 715 may incorporate outside events relating to a user's life into the allocation recommendation process and may attempt to understand the mindset of the user, for example, to anticipate expenses and/or consider financial goals. In some instances, the data received may include or relate to calendar data, location data, expense data, and/or life event data. In some examples, the contextual awareness engine 715 may use the data to anticipate future expenses and/or provide allocation recommendations based on the anticipated future expenses and/or user goals.

The behavioral economics module 720 may receive data from the at least one AI agent 710. In some aspects, the behavioral economics module 720 may consider how the user is interacting with the at least one AI agent. For example, the behavioral economics module 720 may consider whether the user has interacted with (e.g., accepted, rejected, ignored, or exited) recommendations, suggestions, or notifications that have been presented to them. The data received may include or relate to user profile data, user financial goals, and/or user savings or spending patterns. The behavioral economics module 720 may use the data to determine a user's behavior (e.g., how the user is interacting with the at least one AI agent).

The security and compliance module 725 may receive data from the at least one AI agent 710. The security and compliance module 725 may also receive data or other information from one or more of the components of the system 700 such as a user interface module 735. In some aspects, the security and compliance module 725 may help ensure that data received or used by the system 700 is protected and that the operations of the system 700 comply with relevant banking or other regulations. In other aspects, the security and compliance module 725 may manage secure sessions, consent preferences, and/or audit trails. In some instances, the security and compliance module 725 may help provide transparency and/or foster user trust.

A subledger allocator module 730 may receive as input, one or more outputs from the contextual awareness engine 715 and/or the behavioral economics module 720. The subledger allocator module 730 may use the one or more outputs from the contextual awareness engine 715 and/or the behavioral economics module 720 to determine how to distribute incoming monetary deposits across multiple subledgers (e.g., bills, savings, emergency fund) within the at least one bank account of the user. In this way, the subledger allocator module 730 may help to ensure that allocations are tailored and adaptive.

The user interface module 735 may provide a platform for the user to interact with the allocation system 700 or components thereof (e.g., the at least one AI agent 710), review allocation recommendations or other outputs (e.g., notifications, alerts, etc.), provide feedback, and/or make adjustments. In some examples, the user interface module 735 may display one or more recommendations or other information and may support various input methods, such as text, voice, touch, or images.

In some examples, the deposit/data event 705, the at least one AI agent 710, the contextual awareness engine 715, the behavioral economics module 720, the subledger allocator module 730, the user interface module 735, or the security and compliance module 725 of the allocation system 700 may be provided as separate inputs, outputs, components, engines, or modules, and/or provide separate functions. In other examples, one or more of the deposit/data event 705, the at least one AI agent 710, the contextual awareness engine 715, the behavioral economics module 720, the subledger allocator module 730, the user interface module 735, or the security and compliance module 725 of the allocation system 700 may be combined and/or may provide one or more functions.

In additional aspects, the allocation system 700 may include a predictive risk management layer. The predictive risk management layer may include an overdraft prediction engine, an income disruption detection engine, an expense shock absorber, a dept spiral prevention, a fraud risk scoring module, a financial health score module, and/or a stress testing simulator. In some examples, the overdraft prediction engine may forecast the likelihood of overdraft events several days in advance based on expected income or scheduled payments. The income disruption detection engine may identify early warning signs of income loss (e.g., missed deposits, reduced amounts, etc.) or may trigger contingency allocation strategies. The expense shock absorber may maintain dynamic buffer calculations to handle unexpected large expenses. The dept spiral prevention engine may monitor credit utilization to detect early signs of unsustainable debt accumulation or payment patterns to detect early signs of unsustainable debt accumulation. The fraud risk scoring module may assign risk scores to transactions or trigger additional verification for high-risk allocation changes. The financial health score module may calculate comprehensive financial wellness metric that incorporates various inputs (e.g., liquidity, savings rate, debt levels, goal progress, etc.). The stress testing simulator may model impact of adverse scenarios on current allocation strategies (e.g., job loss, medical emergency, market downturn, etc.).

In some instances, the overdraft prediction engine, the income disruption detection engine, the expense shock absorber, the dept spiral prevention engine, the fraud risk scoring module, the financial health score module, and/or the stress testing simulator may be provided as one or more sub-components within the allocation system 700. In other instances, the overdraft prediction engine, the income disruption detection engine, the expense shock absorber, the dept spiral prevention engine, the fraud risk scoring module, the financial health score module, and/or the stress testing simulator may be provided as a sub-module within one or more of the at least one AI agent 710, the contextual awareness engine 715, the behavioral economics module 720, the subledger allocator module 730, the user interface module 735, and/or the security and compliance module 725.

In further aspects, the allocation system 700 may include an interpretation and analysis engine. The interpretation and analysis engine may include an income volatility assessment engine, an expense elasticity analysis engine, a cross-subledger dependency mapping module, a sentiment analysis engine, and/or a comparative benchmarking module. The income volatility assessment engine may calculate income stability scores from each source to recommend fixed vs. percentage-based allocation strategies. The expense elasticity analysis engine may determine whether expense categories are discretionary versus fixed to prioritize allocation adjustments. The cross-subledger dependency mapping module may identify relationships between partitions (e.g., increase spending in one category and decrease spending in another or the like). The sentiment analysis engine may analyze merchant category information such as merchant names or transaction notes to infer purchase intent and emotional spending patterns. The comparative benchmarking module may compare user spending patterns against anonymized cohorts of similar customers (e.g., demographics, income levels, life events, etc.).

In some instances, the income volatility assessment engine, the expense elasticity analysis engine, the cross-subledger dependency mapping module, the sentiment analysis engine, and/or the comparative benchmarking module may be provided as one or more sub-components within the allocation system 700. In other instances, the income volatility assessment engine, the expense elasticity analysis engine, the cross-subledger dependency mapping module, the sentiment analysis engine, and/or the comparative benchmarking module may be provided as a sub-module within one or more of the at least one AI agent 710, the contextual awareness engine 715, the behavioral economics module 720, the subledger allocator module 730, the user interface module 735, and/or the security and compliance module 725.

FIG. 8 illustrates an example contextual awareness engine 800. In some examples, the contextual awareness engine 800 may be, or include aspects of, the contextual awareness engine 715 of FIG. 7.

The contextual awareness engine 800 may include a user data module 805. The user data module 805 may receive data from one or more sources. In some instances, the data may relate to a deposit and/or relate to, or be associated with, a user of at least one bank account. In some examples, the data may be received from the deposit/data event 705 of FIG. 7. In some instances, the user data module 805 may store all or a portion of the data in a database (e.g., the at least one database 115 of FIG. 1). In some examples, the data may include calendar, location, and/or life event data for a user. The user data module 805 may provide all or a portion of the data to a calendar integration module 810, a location data module 815, and/or a life event detection module 820 of the contextual awareness engine 800. In some examples, the user data may include user risk tolerance and/or user financial stress signals.

The calendar integration module 810 may analyze calendar data and may extract upcoming events or expenses from the data. In some instances, the calendar data may include dates, times, events, and/or other information regarding one or more calendar entries of the user or general calendar data such as local, state, national, religious, and/or cultural holidays or other events or the like.

The location data module 815 may analyze location data to provide context for one or more expenses. In some instances, the location data may relate to a user's current location, a location of a user's home or work, or a location associated with one or more transactions (e.g., a location of a hotel that was paid for using the user's at least one bank account) or the like. For example, the location data module 815 may determine whether a withdrawal or other money transfer relates to living expenses, entertainment, personal purchases, work expenses, travel, etc.

The life event detection module 820 may analyze life event data to identify major life events or transitions of a user. In some instances, life event data may include calendar data, location data, transaction data, or other user data. For example, the life detection module 820 may determine if a user is starting a new job, getting married, moving, retiring, expecting a child, planning a vacation, buying a home, has a condition that will require on-going medical treatment, or the like.

The contextual awareness engine 800 may include a context processor engine 825. The context processor engine 825 may receive contextual data or other information from the calendar integration module 810, the location data module 815, and/or the life event detection module 820. In some instances, the context processor engine 825 may synthesize all contextual inputs received.

The contextual awareness engine 800 may include an expense predictor module 830. In some instances, the expense predictor module 830 may use the synthesized contextual information to anticipate future expenses.

The contextual awareness engine 800 may include an allocation recommendation module 835. In some instances, the allocation recommendation module 835 may determine whether or how deposits should be allocated based on the anticipated future expenses. In some examples, the allocation recommendation module 835 may generate one or more outputs in the form of one or more proposed allocation recommendations that may be provided to the context processor engine 825 in a feedback loop so that the one or more proposed recommendations can be continuously refined based on user feedback and/or new data. In some instances, the one or more proposed allocation recommendations may be a recommendation to create one or more subledgers in at least one bank account of a user, a recommendation to allocate all or a portion of current or future deposited funds to at least one bank account, and/or a recommendation to allocate all or a portion of current or future deposited funds to one or more subledgers in at least one bank account.

A contextual output 840 may be generated by one or more components of the context awareness engine 800. In some examples, the contextual output 840 may be provided in the form of contextualized data and/or an allocation or other recommendation for a user. In some instances, the contextual output 840 may be provided to the allocation system 700. For example, the contextual output 840 may be provided to the subledger allocator module 730 of the allocation system 700

In some examples, the user data module 805, the calendar integration module 810, the location data module 815, the life event detection module 820, the context processor engine 825, the expense predictor module 830, the allocation recommendation module 835, or the contextual output 840 of the contextual awareness engine 800 may be provided as separate inputs, outputs, components, engines, or modules, and/or provide separate functions. In other examples, one or more of the user data module 805, the calendar integration module 810, the location data module 815, the life event detection module 820, the context processor engine 825, the expense predictor module 830, the allocation recommendation module 835, or the contextual output 840 of the contextual awareness engine 800 may be combined and/or may provide one or more functions.

FIG. 9 illustrates an example behavioral economics module 900. In some examples, the behavioral economics module 900 may be, or include aspects of, the behavioral economics module 720 of FIG. 7.

The behavioral economics module 900 may include a user data module 905. The user data module 905 may receive data from one or more sources. In some instances, the data may relate to a deposit and/or relate to, or be associated with, a user v. In some examples, the data may be received from the deposit/data event 705 of FIG. 7. In some instances, the user data module 905 may store all or a portion of the data in a database (e.g., the at least one database 115 of FIG. 1). In some examples, the data may include user preferences and/or user transaction history. The user data module 905 may provide all or a portion of the data to a goal setting module 910 and/or a savings pattern analysis module 915 of the behavioral economics module 900.

The goal setting module 910 may receive data relating to a user's financial objectives or goals. In some instances, the goal setting module 910 may generate or provide a user interface or other mechanism to allow users to provide or define their financial objectives or goals. In some examples, the user interface or other mechanism may be provided via the user interface module 735 of FIG. 7.

The savings pattern analysis module 900 may receive data relating to a user's transaction history. The savings pattern analysis module 900 may review and analyze the user's transaction history to determine a user's savings and/or spending habits.

A nudge engine 920 may generate one or more prompts, nudges, or other notifications (e.g., alerts, etc.) to be displayed to users. For example, in some instances, if a recommendation or other information is provided to a user (e.g., via the user interface module 735 of FIG. 7), and no response is received, then the nudge engine may generate a prompt, nudge, or other notification. In other examples, a prompt, nudge, or other notification may be provided to a user if new deposits or data are received or upon the generation of a new recommendation. In some instances, a prompt, nudge, or other notification may be generated after a time period. In some examples, the time period may be 30 seconds, 1 minute, 2 minutes, 3 minutes, 5 minutes, 10 minutes 15 minute, etc., or the time period may be 1 hour, 2 hours, 3 hours, etc. or the time period may be a day, two days, a week, two weeks, a month, three months, etc.

The behavioral economics module 900 may include a personalized suggestions module 925. In some instances, the personalized suggestions module 925 may prepare and/or provide tailored advice for users.

The behavioral economics module 900 may include an allocation adjustment module 930. In some instances, the allocation adjustment module 930 may modify subledger allocations based on prompts, nudges, or other notifications and/or user goals.

The behavioral economics module 900 may include a progress tracker module 935. In some instances, the progress tracker module 935 may monitor user progress toward financial objectives or goals and/or may provide user progress reports.

The behavioral economics module 900 may include a user response module 940. The user response module 940 may capture user actions and/or feedback.

The behavioral economics module 900 may include a behavioral data update module 945. The behavioral data update module 945 may update user data such as preferences and savings or spending patterns. In some instances, the updates are provided to one or more of the components of the behavioral economics module 900. For example, the updates may be provided to the nudge engine 920, which may provide a prompt, nudge or other notification to the user.

A behavioral output 950 may be provided by one or more components of the behavioral economics module 900. In some examples, the behavioral output 950 may be provided in the form of a prompt, nudge or other notification, advice for a user, user actions or feedback, modifications to bank account or subledger allocations, and/or a user progress report. In some instances, the behavioral output 950 may be provided to the allocation system 700. For example, the behavioral output 950 may be provided to the subledger allocator module 730 of the allocation system 700.

In some examples, the user data module 905, the goal setting module 910, the savings pattern analysis module 915, the nudge engine 920, the personalized suggestions module 925, the allocation adjustment module 930, the progress tracker module 935, the user response module 940, the behavior data update module 945, or the behavioral output 950 of the contextual awareness engine 800 may be provided as separate inputs, outputs, components, engines, or modules, and/or provide separate functions. In other examples, one or more of the user data module 905, the goal setting module 910, the savings pattern analysis module 915, the nudge engine 920, the personalized suggestions module 925, the allocation adjustment module 930, the progress tracker module 935, the user response module 940, the behavior data update module 945, or the behavioral output 950 of the contextual awareness engine 800 may be combined and/or may provide one or more functions.

In some aspects, the behavioral economics module 900 may also include a mental accounting optimizer, a commitment device generator, a default architecture designer, a loss aversion framer, a social proof integrator, a temporal discounting compensator, and/or a choice architecture optimizer. In some instances, the mental accounting optimizer may leverage psychological tendency to treat money differently based on source to strengthen partition adherence or based on intended use to strengthen partition adherence. The commitment device generator may create voluntary constraints to overcome present bias (e.g., the ability to lock a savings sub-ledger or the like). The default architecture designer may strategically set default allocation options to nudge users toward optimal behavior while preserving choice. The loss aversion framer may present recommendations emphasizing potential losses from inaction. The social proof integrator may show anonymized comparison to similar users. The temporal discounting compensator may adjust recommendations to account for users'tendency to undervalue future benefits. The choice architecture optimizer may limit decision paralysis by presenting a small number of options rather than overwhelming users.

In some instances, the mental accounting optimizer, the commitment device generator, the default architecture designer, the loss aversion framer, the social proof integrator, the temporal discounting compensator, and/or the choice architecture optimizer may be included as one or more sub-components of the behavioral economics module 900. In other instances, the mental accounting optimizer, the commitment device generator, the default architecture designer, the loss aversion framer, the social proof integrator, the temporal discounting compensator, and/or the choice architecture optimizer may be included as one or more sub-modules within one or more of the user data module 905, the goal setting module 910, the savings pattern analysis module 915, the nudge engine 920, the personalized suggestions module 925, the allocation adjustment module 930, the progress tracker module 935, the user response module 940, and/or the behavior data update module 945.

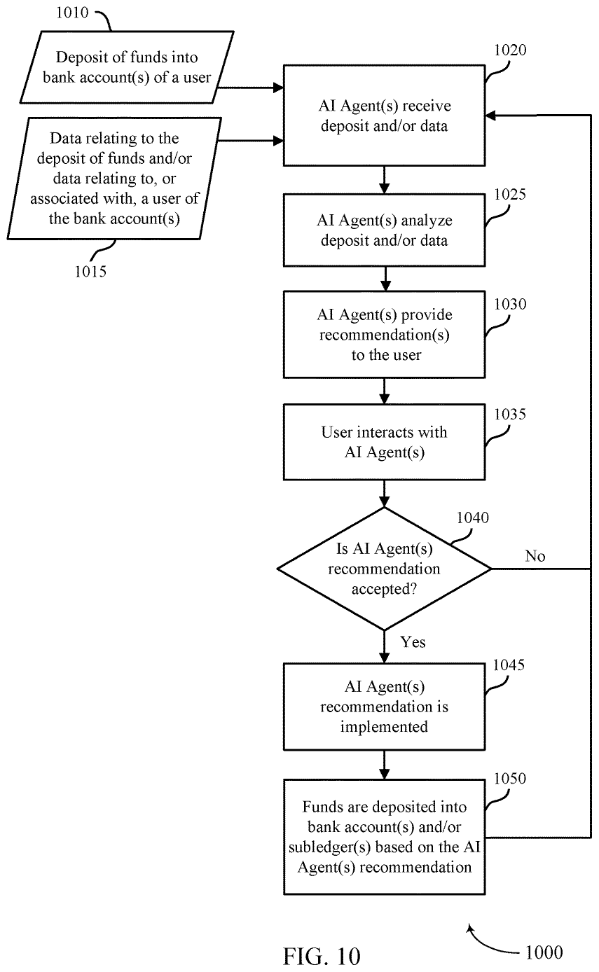

FIG. 10 depicts a flowchart of an example method 1000. In some instances, the method 1000 is for using at least one AI agent to allocate funds into one or more bank accounts of a user and/or one or more subledgers of the one or more bank accounts. In some examples, the one or more bank accounts may be, or include aspects of, the one or more bank accounts 130 of FIG. 1, the one or more bank accounts 305 of FIG. 3, the one or more bank accounts 403 of FIG. 4, and/or the one or more bank accounts 505 of FIG. 5; and, the one or more subledgers may be, or include aspects of, the one or more subledgers 135 of FIG. 1, the one or more subledgers 315 of FIG. 3, the one or more subledgers 415 of FIG. 4, and/or the one or more subledgers 515 of FIG. 5. In some examples, the at least one AI agent may be, or include aspects of, the one or more AI Agents 550 of FIG. 5 and/or the at least one AI agent 710 of FIG. 7. Furthermore, the method 1000 may be performed or implemented all, or in part, by the system 100 of FIG. 1, the allocation system 700 of FIG. 7, the context awareness engine 800 of FIG. 8, the behavioral economics module 900 of FIG. 9, the computer system 1100 of FIG. 11, and/or by one or more computing devices or components of such systems, engines, or modules (e.g., one or more AI agents).

At 1010, a deposit of funds into one or more bank accounts of a user may be received. In some instances, the one or more bank accounts may have one or more subledgers. In other instances, the one or more bank accounts may have no subledgers. In some examples, the deposit of funds may be, or include aspects of, the deposit/data event 705 of FIG. 7.

At 1015, data relating to the deposit of funds and/or data relating to, or associated with, a user of the one or more bank accounts may be received. The data relating to the deposit of funds may include the name of a source that is depositing the funds into one or more bank accounts, a transaction type (e.g., ACH, cash, check, cashier's check, P2P, etc.), a dollar amount of the deposit received, a date the deposit was sent by the source and/or a date the deposit was received by the one or more bank accounts, and/or an interval or frequency of the deposit (e.g., weekly, two times a month, monthly, one-time, sporadically, etc.). In some instances, the data relating to the deposit of funds may include the name or other indicator of the one or more bank accounts and/or one or more subledgers in the one or more bank accounts into which the funds are being deposited. Other information about the deposit may also include a time of day the deposit was made. In some examples, the data may be, or include aspects of, the deposit/data event 705 of FIG. 7.

The data relating to, or associated with, a user of the one or more bank accounts may include data regarding the use of the funds deposited into the one or more bank accounts. For example, the data may include transaction data such as whether all or a portion of the funds deposited is or will be used for bills, purchases, money transfers, savings, or withdrawals. In some instances, the data received may include a date, time, transaction type, or an amount of the funds that is or will be used to pay a bill, make a purchase, transfer money, saved, or withdrawn. The data may also include a payee's name, address, merchant type, and other relevant payee information. If the one or more bank accounts have one or more subledgers, the data may also include to which of the one or more subledgers the funds will be deposited or from which of the one or more subledgers funds will be used. Furthermore, the data may include the frequency at which the payments, purchases, transfers, savings, and/or withdrawals are occurring, for example, once a week, once every two weeks, once a month, one time, sporadically, etc.

The data relating to, or associated with, a user of the one or more bank accounts may also include user profile or other user data. For example, the data may include demographic data, location data, calendar data, life event data, spending or savings preferences, expenses, financial objectives of goals, or the like. In some examples, the data received may be from various sources including those that are external to a bank or other financial institution that provide the one or more bank accounts or subledgers.

At 1020, the at least one AI agent may receive the deposit and/or the data (e.g., data relating to the deposit and/or data relating to, or associated with, a user). In some examples, the deposit and/or the data may be saved to one or more databases (e.g., the database 115 of FIG. 1).

At 1025, the at least one AI agent may analyze the deposit and/or the data received. In some instances, the AI agent may use machine learning or other techniques to provide a recommendation to the user regarding the deposit or data received at 1020. For example, the at least one AI agent may use contextual or behavioral information (e.g., pattern recognition, spend/save behavior, context for behaviors, or the like) that is generated from the deposit or data received. In some examples, the contextual or behavioral information may be generated by a contextual awareness engine (e.g., the contextual awareness engine 715 of FIG. 7 or the contextual awareness engine 800 of FIG. 8) and/or a behavioral economics module (e.g., the behavioral economics module 720 of FIG. 7 or the behavioral economics module 900 of FIG. 9) associated with the at least one AI agent. In other examples, anomalies may be detected and/or analyzed by the at least one AI agent.

At 1030, at least one AI agent may provide at least one recommendation or other information to the user. In some instances, the at least one recommendation may be an allocation strategy for funds deposited from one or more sources. The allocation strategy may provide for the deposit of funds from one or more sources into the one or more bank accounts or into one or more subledgers. In other instances, the recommendation may be to select one or more subledgers if the bank account has no subledgers and to deposit a certain amount of the funds from the source into the one or more subledgers. In another instance, the recommendation may be to add more bank accounts and/or subledgers to the one or more bank accounts and/or allocate a portion of the funds received from the source into the new bank account(s) or subledger(s). In other instances, the recommendation may be to allocate a portion of the funds to an existing bank account or subledger. In a further instance, the recommendation may be to move an allocated portion of the funds from one bank account and/or subledger to another bank account and/or subledger or to a general bank account and/or subledger. In some instances, the recommendation or other information may be provided or displayed to the user via a user interface. In some examples, the user interface may be provided or displayed via a user interface module (e.g., the user interface module 735 of FIG. 7) that is associated with the at least one AI agent.

At 1035, a user of the one or more bank accounts or subledgers may interact with the at least one AI agent. In some examples, a user may receive a recommendation from the at least one AI agent, via a user interface, and the user may ask questions or provide inquiries or queries to the at least one AI agent. In other examples, the user may provide additional information to the at least one AI agent with respect to the recommendation. In some instances, the at least one AI agent may provide a new, revised, or modified recommendation based on the interactions with the user. In some examples, if a joint bank account exists or is being created, then more than one user of the one or more bank accounts or subledgers may interact with the at least one AI agent. In other examples, an external advisor (e.g., a financial advisor) or other authorized party may also have access to the one or more bank accounts or subledgers of the user or joint users and may also be able to interact with the at least one AI agent.

At 1040, a user may accept or reject the recommendation provided by the at least one AI agent. In some examples, the user may provide a response (e.g., an acceptance or rejection) to the recommendation via a user interface.

If a user rejects the recommendation, then the rejection may be provided to the at least one AI agent. In some examples, the at least one AI agent may use the rejection information to modify, revise, or prepare future recommendations.

If a user accepts the recommendation, at 1045, the at least one AI agent may implement the recommendation. For example, if the at least one AI agent recommends that one or more bank accounts and/or one or more subledgers be added to the one or more bank accounts, the bank accounts and/or the subledgers may be created. In other instances, the at least one AI agent may implement one or more financial allocation strategies that have been recommended. In some instances, the recommendation may be implemented via a subledger allocator module (e.g., the subledger allocator module 730 of FIG. 7) that is associated with the at least one AI agent.

At 1050, the funds received may be deposited into the one or more bank accounts or subledgers based on the accepted recommendation. For example, if the at least one AI agent's recommendation was to add a bank account or a subledger to one of the user's bank accounts and then allocate a portion of the funds deposited by a specific source to an existing or added bank account or subledger, then if the deposit received is from the specific source, the portion of the funds allocated to the existing or added bank account or subledger will be deposited into the existing or added bank account or subledger per the accepted recommendation. In some instances, the acceptance, implementation, and/or information regarding how the funds are deposited may be provided to the at least one AI agent so that the at least one AI agent can use the information to provide, refine, or modify future recommendations.

FIG. 11 is a schematic block diagram of an example computer system 1100 that supports financial allocation or other recommendations via one or more AI agents 1130, according to an example. The computer system 1100 may include a device 1105 and a network 1110. In some instances, the device 1105 may be, or include aspects of, the one or more system computing device 110 or the user computing devices 145 of FIG. 1. In some instances, the network 1110 may be a cloud network.

The device 1105 may include a communication module 1125, one or more AI agents 1130, memory 1135 having processor-executable software code 1145 stored therein, a bank account(s) and subledger(s) module 1150, at least one processor 1155, an input/output (I/O) controller 1160, and at least one bus 1165. In some instances, the one or more AI agents 1130 may be contained within the single device 1105, while in other examples, the one or more AI agents 1130 may be distributed among one or more devices 1105 and/or stored in a server or a database of the network 1110. In some instances, some AI agents 1130 may be located within the device 1105 while additional AI agents 1130 may be located external to the device 1105 on one or more other devices.

The communication module 1125 may facilitate communication between the device 1105 and the network 1110 and/or communication between the various components of the device 1105 and the network 1110 via at least one wired or wireless network connection 1120.

The one or more AI agents 1130 may be any of the AI agents discussed herein (e.g., the one or more AI agents 550 of FIG. 5 or the at least one AI agent 710 of FIG. 7). In some instances, the one or more AI agents 1130 may be a single agent or multiple agents. In other instances, the one or more agents 1130 may be separate modules within a single AI agent. The one or more AI agents 1130 may receive data (e.g., data 555 of FIG. 5, the deposit/data event 705 of FIG. 7, or the data 1015 of FIG. 10) about one or more bank accounts and/or users, including data about income received (e.g., deposits, money transfers, etc.), withdrawals, or other transactions, and/or data about a user's expenses, location, demographics, preferences, financial goals, life events, or the like, and may analyze the data. In some instances, the data received may be stored in one or more databases 1170 (e.g., the at least one database 115 of FIG. 1).

In some instances, the data may be used to train a model used by the AI agents 1130. The one or more AI agents 1130 may analyze the data received and determine one or more recommendations (e.g., the recommendations 560 of FIG. 5) or other information to provide to the user of the one or more bank accounts based on the data. Additionally, the one or more AI agents 1130 may perform at least one operation based on the analysis, such as outputting indications or other notifications including the one or more recommendations. In some instances, the recommendations may be for one or more income allocation strategies and/or subledgers for the one or more bank accounts. The indications or notifications may further include information regarding the reason for the recommendation based on the data. The one or more AI agents 1130 may also provide means for interacting with a user. For example, if a user has a question about the one or more recommendations or other inquiry, the user may be able to ask the AI agent 1130 their question via, for example, one or more pop-up windows or screens. In addition, the one or more AI agents 1130 may provide the user with the ability to accept, reject, ignore, or exit the one or more recommendations presented to the user.

In some instances, the data received by the one or more AI agents 1130 may be data relating to whether a user followed, rejected, ignored, or exited any recommendations presented by the AI agents 1130. For example, if the AI agents 1130 recommend that the user add one or more bank accounts and/or subledgers, the AI agents 1130 may receive data that the user added one or more bank accounts or subledgers. Likewise, if the user does not add any bank accounts or subledgers, adds less than the number of banks accounts or subledgers recommended, ignores or exits the recommendation the AI agent 1130 may receive this data as well. In other examples, the AI agent 1130 may recommend that the user add or change an income allocation strategy for one or more bank accounts and/or subledgers. If the user accepts the recommendation in full, a part of the recommendation, does not accept the recommendation, ignores or exits the recommendation, then the AI agent 1130 may receive this information. In other instances, whether a user clicks on or otherwise interacts with a recommendation or other notification provided by the AI agent 1130, ignores the recommendation or other notification, or exits out of the AI agent 1130, recommendation or notification may also be data provided to the one or more AI agents 1130. In some instances, the data collected regarding the user's actions after a recommendation is received may be used by the AI agent 1130 in presenting future recommendations to the user.

To perform the analysis and other functions, the one or more AI agents 1130 may include a natural language processing (NLP) based virtual assistant for technical support, which may include capabilities for receiving, analyzing, and resolving queries using a trained model. The one or more AI agents 1130 may handle text-based, audio-based, image-based, and screenshot-based queries, enhancing accessibility and flexibility in query handling. The system may use machine learning (ML) algorithms such as ChatGPT, Sentence Bidirectional Encoder Representations from Transformers (SBERT) and Semantic Textual Similarity (STS) to interpret query context and/or identify root causes (e.g., relationships between the cause and effect of an incident). In other examples, at least some of the one or more AI agents 1130 may include a trained model. The trained model may be subjected to supervised learning using data received from various applications and documents of the organization or elsewhere. In some instances, the AI agents 1130 may receive the data from other devices connected via the network 1110. The data may help the model to train and then identify the context of at least one query. The trained model may undergo further training when handling the at least one query. The trained model may use various ML algorithms, including but not limited to, ChatGPT, SBERT, STS, and the like. In an example, the phrases “how old are you” and “what is your age” are semantically similar and the trained model is capable of identifying queries with similar context using the ML algorithms. The STS algorithm may enable the identification of the context of the at least one query and other similar queries resolved in the past by the technical support team and the trained model.

In an example, the device 1105 may also include or be in communication with and/or operatively connected to the one or more databases 1170 (e.g., the at least one database 115 of FIG. 1). In some examples, the one or more databases 1170 may be configured to store a plurality of queries and the corresponding resolution of the queries. In some examples, the device 1105 may be in communication with the one or more databases 1170 via the communication module 1125 and at least one wired or wireless network connection 1120. In another non-limiting example, the database 1170 may also store the associated context along with parameters of the at least one query identified using the model trained on the ML algorithms SBERT, STS, and the like. The parameters associated with the plurality of queries may include the root cause of the query, the content of the query, the context of the query, the associated resolution of the query, the response and feedback to the recommended resolution to similar queries raised in the past, and the like. In other examples, the one or more databases 1170 may store data associated with one or more user bank accounts. For example, the data may include data regarding one or more sources, an amount of funds received from the one or more sources, the frequency of or the intervals at which the funds received from the one or more sources, the type of transaction used to deposit the funds from the one or more sources into the bank account (e.g., ACH, cash, check, cashier's check, money order, P2P Payment, etc.), one or more allocation strategies for the funds received, one or more subledgers in the bank account, expenses paid using the bank account and/or debit transactions for the one or more subledgers.

The bank account(s) and subledger(s) module 1150 may receive requests to create one or more bank accounts and/or one or more subledgers in the one or more bank accounts. The bank account(s) and subledger(s) module 1150 may communicate with the one or more AI agents 1130 and/or other components of the computing system 1100 to implement the one or more bank accounts and/or the one or more subledgers in the one or more bank accounts in response to a user's request to create the one or more bank accounts or subledgers or the user's acceptance of a recommendation from the AI agent 1130 to open or create one or more bank accounts or subledgers. The bank account(s) and subledger(s) module 1150 may be responsible for implementing one or more income allocations strategies for the one or more bank accounts and/or the one or more subledgers as discussed herein. In some examples, the bank account(s) and subledgers(s) module 1150 and the one or more AI agents 1130 may be separate modules as shown in FIG. 11; and, in other examples, the bank account(s) and subledgers(s) module 1150 and the one or more AI agents 1130 may be contained within a single module.

Memory 1135 may be provided in the form of a single memory unit or multiple memory units and may be one or more articles of manufacture and/or machine components. Memory 1135 may include static memory, dynamic memory, or both in communication. In some examples, memory 1135 may be one or more tangible storage mediums that can store data and executable instructions and may be non-transitory during the time instructions are stored therein. Memory 1135 may be volatile or non-volatile, secure and/or encrypted, unsecure and/or unencrypted.

The software code 1145 stored in the memory 1135 may include the software code needed for the one or more AI agents 1130, the bank account(s) and subledger(s) module 1150, and/or the other components to operate.

The at least one processor 1155, in some instances, may be a general-purpose processor or may be part of an application-specific integrated circuit (ASIC). In other instances, the at least one processor 1155 may be a microprocessor, a microcomputer, a processor chip, a controller, a microcontroller, a digital signal processor (DSP), a state machine, or a programmable logic device (PLD). Additionally, any processor described herein may be provided in the form of a single processor, multiple processors, and/or parallel processors. Multiple processors may be included in or coupled to, a single device or multiple devices.

The I/O controller 1160 may manage input and output signals for the device 1105. The I/O controller 1160 may also manage peripherals not integrated into the device 1105. In some cases, the I/O controller 1160 may represent a physical connection or port to an external peripheral. In some cases, the I/O controller 1160 may utilize an operating system such as iOS®, ANDROID®, MS-DOS®, MS-WINDOWS®, OS/2®, UNIX®, LINUX®, or another known operating system. Additionally, or alternatively, the I/O controller 1160 may represent or interact with a modem, a keyboard, a mouse, a joystick, a trackball, a microphone, a touchpad, a touchscreen, a display, a screen, a monitor, a speaker, or similar devices. In some cases, the I/O controller 1160 may be implemented as part of one or more processors, such as the at least one processor 1155. In some cases, a user may interact with the device 1105 via the I/O controller 1160 or via hardware components controlled by the I/O controller 1160.

The components of the device 1105 may be interconnected and communicate via the at least one bus 1165 or other communication link. The at least one bus 1165 may enable communication via any standard or specification such as peripheral component interconnect, peripheral component interconnect express, parallel advanced technology attachment, or serial advanced technology attachment. The at least one bus 1165 may be provided in the form of a single bus or multiple buses that are operatively interconnected.

The various illustrative blocks and components described in connection with the disclosure herein may be implemented or performed using a general-purpose processor, a Digital Signal Processing device (DSP), an ASIC, a Central Processing Unit (CPU), a graphics processing unit (GPU), a neural processing unit (NPU), a Field Programmable Gate Array (FPGA) or other PLD, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by multiple processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, controllers, firmware, hardwiring, circuitry, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include random access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, the software may be transmitted from a website, server, or other remote source using a wired technology such as a coaxial cable, fiber optic cable, twisted pair, digital subscriber line (DSL), universal serial bus (USB), high-definition multimedia interface (HDMI), video graphics array (VGA), digital visual interface (DVI), thunderbolt cable, power cable, ribbon cable, integrated services digital network (ISDN), or wireless technologies such as wireless fidelity (Wi-Fi), Bluetooth, cellular network, near-field communication (NFC), Zigbee, long range (LoRa), infrared (IR), radio frequency identification (RFID), light fidelity (Li-Fi), satellite, ultra-wideband (UWB), millimeter wave (mmWave), and microwave. The wired and or wireless technologies are included in the definition of computer-readable medium. Disk and disc, as used herein, include a compact disk (CD), laser disc, optical disc, digital versatile disc (DVD), floppy disk, and Blu-ray disc. Disks or discs may reproduce data magnetically or optically using lasers. Combinations of the above are also included within the scope of computer-readable media. Any functions or operations described herein as being capable of being performed by a memory may be performed by multiple memories that, individually or collectively, are capable of performing the described functions or operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

Machine learning includes one or more systems that may be adapted to generate, train, and execute one or more trained learning models, nodes, neural networks, gradient boosting algorithms, mutual information classifiers, random forest classifications, and other machine learning and artificial intelligence-based algorithms or models to process inputs, parameters, and other data elements. In some examples, the one or more trained learning models can include deep learning, machine learning, neural networks, computer vision, and similar advanced artificial intelligence-based technologies. In some examples, the machine learning or artificial intelligence may use additional inputs and/or feedback loops to an iterative training process for enhanced data processing and improved outcomes.

Although the disclosure may describe components and functions that may be implemented in a particular example with reference to a particular standard or protocol, the disclosure is not limited to the standard or protocol. Other standards or protocols supporting similar functionality are considered equivalents thereof.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Furthermore, “and/or” as used in a list of items indicates an inclusive list such that, for example, a list of at least one of A, B, and/or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B. For example, as used herein, the phrase “based on” shall be construed in the same manner as the phrase “based at least in part on.”

As used herein, including in the claims, the article “a” before a noun may be open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The terms “determine,” “determining,” “identify,” or “identifying” encompasses a variety of actions and, therefore, “determining” or “identifying” can include calculating, computing, processing, deriving, investigating, looking up (such as via looking up in a table, a database, or another data structure), receiving, ascertaining, and the like. Also, “determining” or “identifying” can include receiving (for example, receiving information), accessing (for example, accessing data stored in memory), retrieving, and the like. Also, “determining” or “identifying” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label or other subsequent reference label.

The description set forth herein, in connection with the appended figures, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples. The features of the various examples described herein may be combined in any suitable manner. It is contemplated that one or more features from one example may be incorporated into another example unless explicitly stated otherwise. The combinations of features from different examples are within the scope of the disclosure.

It will be appreciated by those skilled in the art that while the disclosure has been described above in connection with particular examples, the disclosure is not necessarily so limited, and that numerous other examples, uses, means for, modifications and departures from the examples, uses, and means for are intended to be encompassed by the claims attached hereto. The entire disclosure of each patent and publication cited herein is incorporated by reference, as if each such patent or publication were individually incorporated by reference herein. Various features and advantages of the disclosure are set forth in the following claims.

What is claimed is:

1. A device, comprising:
at least one memory storing processor-executable code; and
at least one processor communicatively connected with the at least one memory and individually or collectively operable to execute the code to cause the device to:
receive a request from a user to open or access at least one bank account associated with a bank;
receive one or more subledgers for the at least one bank account;
create the one or more subledgers in the at least one bank account;
receive at least one allocation strategy for the one or more subledgers;
receive funds from at least one source;
determine which of the one or more subledgers to deposit the funds into based on the at least one allocation strategy; and
deposit funds from the at least one source into the one or more subledgers.

2. The device of claim 1, wherein the at least one processor operable to execute the code further causes the device to:
save the at least one allocation strategy in a database associated with the bank.

3. The device of claim 1, wherein the one or more subledgers in the at least one bank account are provided by the user.

4. The device of claim 1, wherein the one or more subledgers in the at least one bank account are selected by the user from a list provided by the bank or one or more artificial intelligence (AI) agents associated with the bank.

5. The device of claim 1, wherein the at least one source is a company, a financial institution, a payment service, an individual, a financial instrument, or any combination thereof.

6. The device of claim 1, wherein the at least one allocation strategy is provided by the user.

7. The device of claim 1, wherein one or more artificial intelligence (AI) agents associated with the bank provide a recommendation to modify the at least one allocation strategy via a user interface.

8. The device of claim 7, wherein the user accepts or rejects the recommendation to modify the at least one allocation strategy via the user interface.

9. A method, the method comprising:
receiving deposit data for funds deposited into at least one bank account via at least one artificial intelligence (AI) agent, wherein the funds are from at least one source;
receiving user data associated with a user of the at least one bank account at the at least one AI agent;
outputting a recommendation of the at least one AI agent based at least in part on the deposit data and the user data, wherein the recommendation is a strategy to allocate a portion of the funds from the at least one source into one or more subledgers in the at least one bank account; and
receiving a response from the user regarding the recommendation of the at least one AI agent.

10. The method of claim 9, wherein the response from the user is an acceptance, a rejection or an inquiry.

11. The method of claim 9, wherein the response from the user is an acceptance, the method further comprising:
depositing the portion of the funds from the at least one source into the at least one subledger in accordance with the recommendation of the at least one AI agent.

12. The method of claim 9, wherein the deposit data includes one or more of a deposit amount, a deposit time, a deposit date, a type of deposit, a source of the deposit, deposit frequency, deposit amount variability, or deposit amount consistency.

13. The method of claim 9, wherein the user data includes one or more of user demographic data, user location data, user calendar data, user life event data, user financial goals data, user preferences, user transaction history, user risk tolerance, or user financial stress signals.

14. The method of claim 9, further comprising:
providing a nudge to the user if the response is not received within a time period.

15. The method of claim 9, wherein the recommendation of the at least one AI agent is provided via a user interface, and wherein the response from the user is received via the user interface.

16. A system, comprising:
at least one artificial intelligence (AI) agent;
at least one memory storing processor-executable code; and
at least one processor communicatively connected with the at least one memory individually or collectively operable to execute the code to cause the system to:
receive a deposit event for a bank account of a user via the at least one AI agent, wherein the deposit event includes data;
generate a contextual output using all or a portion of the data;
generate a behavioral output using all or a portion of the data;
generate a subledger allocation strategy using the contextual output and the behavioral output; and
provide the subledger allocation strategy to the user via a user interface.

17. The system of claim 16, wherein the data includes data about the deposit event or data about the user of the bank account.

18. The system of claim 16, further comprising:
a contextual awareness engine, wherein the contextual output is generated by the contextual awareness engine; and
a behavioral economics module, wherein the behavioral output is generated by the behavioral economics module.

19. The system of claim 16, wherein the at least one processor operable to execute the code further causes the system to:
receive an acceptance of the subledger allocation strategy from the user via the user interface; and
implement the subledger allocation strategy.

20. The system of claim 16, wherein the at least one processor operable to execute the code further causes the system to:
modify the subledger allocation strategy based on feedback from the user.
